(19) United States
(12) Patent Application Publication
(10) Pub. No.: US 2026/0289027 A1
(43) Pub. Date: Sep. 24, 2026

(54) SYSTEM

(71) Applicant: SoftBank Group Corp., Tokyo (JP)

(72) Inventor: Naoki EGAWA, Tokyo (JP)

(73) Assignee: SoftBank Group Corp., Tokyo (JP)

(21) Appl. No.: 19/557,224

(22) Filed: Mar. 5, 2026

(30) Foreign Application Priority Data
Mar. 19, 2025 (JP) 2025-044924

(51) Int. Cl. G06F 30/12; G06F 30/13; G06F 111/04; G06F 111/16

(52) U.S. Cl. CPC G06F 30/12; G06F 30/13; G06F 2111/04; G06F 2111/16

(57) ABSTRACT

A system comprising a processor, wherein the processor is configured to: acquire an image of a space by using an imaging device; analyze the acquired image to extract features in the image and determine a category of the space based on the extracted features; generate a prompt for instructing planning of an interior design that conforms to the determined category; and input the generated prompt into a generative AI model.

### CROSS-REFERENCE TO RELATED APPLICATION

This application is based on and claims priority under 35 USC 119 from Japanese Patent Application No. 2025-044924 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interior design support systems generally require manual input of room attributes, style preferences, and budget constraints, and rely heavily on human designers or rule-based engines to propose interior designs. Such approaches are time-consuming, lack scalability, and often fail to provide highly personalized proposals that are visually easy to understand. In particular, existing systems do not sufficiently utilize image analysis of the actual space and generative AI models in an integrated manner, and therefore have limited capability to automatically derive suitable interior design concepts from real room images. Furthermore, conventional systems do not adequately link generated design proposals with concrete purchase options on online platforms, nor do they effectively incorporate user budget constraints into the design generation process. Accordingly, there is a need for a system that automatically analyzes images of a space, determines an appropriate category of the space, generates prompts for instructing a generative AI model to produce interior designs suited to the determined category, and, in addition, is capable of deriving product purchase information and handling budget constraints in an integrated and automated manner.

### SUMMARY

In order to solve the above-described problems, a system according to one aspect of the present invention comprises a processor, wherein the processor is configured to acquire an image of a space by using an imaging device, analyze the acquired image to extract features in the image and determine a category of the space based on the extracted features, and generate a prompt for instructing planning of an interior design that conforms to the determined category, and input the generated prompt into a generative AI model. According to another aspect of the present invention, the processor is further configured to analyze elements in a visual representation of a generated interior design, acquire product information corresponding to the elements, and provide links to online platforms on which products related to the elements are available for purchase, based on the visual representation of the generated interior design. According to still another aspect of the present invention, the processor is configured to receive budget information from a user, generate a prompt including the budget information, input the prompt into the generative AI model, and generate, by use of the generative AI model, an interior design proposal based on the budget information so as to propose an interior design that conforms to the budget. By these means, the system automatically generates interior design proposals that are adapted to the actual space, provides concrete purchasing options, and reflects user budget constraints, thereby improving convenience, efficiency, and personalization in interior design support.

The term “processor” refers to any hardware and/or software component, including but not limited to a central processing unit (CPU), graphics processing unit (GPU), microcontroller, application-specific integrated circuit (ASIC), field-programmable gate array (FPGA), or a combination thereof, that is configured to execute instructions for performing the functions described in the present specification and claims.

The term “imaging device” refers to any device capable of capturing an image of a physical space, including but not limited to a digital camera, a camera integrated in a smartphone or tablet, a webcam, or any other optical sensor system capable of generating digital image data.

The term “image of a space” refers to digital image data representing at least a portion of a physical environment, such as a room, corridor, hall, or other interior or exterior area, which is captured by the imaging device and used as input for analysis by the processor.

The term “features in the image” refers to identifiable attributes or elements extracted from the image of the space, including but not limited to shapes, edges, textures, colors, objects, furniture, architectural elements, spatial relationships, and any other visual characteristic that can be detected through image analysis.

The term “category of the space” refers to a classification assigned to the space based on the extracted features, such classification including, for example, room type (such as living room, bedroom, kitchen), usage type (such as residential, office, commercial), style type (such as modern, classic, industrial), or any other predefined category relevant to interior design planning.

The term “prompt” refers to a data structure or textual or symbolic instruction set generated by the processor and provided as input to a generative AI model, the prompt specifying conditions, constraints, or guidelines, such as the determined category of the space or budget information, for planning or generating an interior design.

The term “interior design” refers to a conceptual or concrete arrangement of elements within the space, including but not limited to furniture, fixtures, lighting, decorations, colors, materials, and layouts, which is suitable for the determined category or for user-specified conditions such as budget.

The term “planning of an interior design” refers to the process of selecting, arranging, and specifying interior elements for the space according to one or more criteria, including at least the determined category of the space and optionally additional constraints such as dimensions, functions, or budget.

The term “generative AI model” refers to any machine learning model configured to generate new data or content, including but not limited to text, images, three-dimensional data, or structured design information, in response to a prompt, such as a large language model, a generative adversarial network (GAN), a diffusion model, or any other generative model.

The term “visual representation of a generated interior design” refers to an output produced based on the generated interior design, including at least a two-dimensional image, a sequence of images, a rendered scene, or any other visual format that depicts the interior design within the space or in a model of the space.

The term “elements in a visual representation” refers to visually distinguishable components depicted in the visual representation of the generated interior design, including but not limited to individual pieces of furniture, lighting devices, decorative objects, wall or floor finishes, and any other identifiable items or features included in the design.

The term “product information” refers to data associated with a tangible or digital item corresponding to an element in the visual representation, such data including at least one of a product name, model number, category, price, manufacturer, supplier, availability, and a URL or identifier for purchase.

The term “online platforms” refers to electronic commerce services or websites accessible over a network, including but not limited to online shopping sites, marketplace platforms, or vendor-specific web stores, through which products corresponding to elements of the interior design can be browsed and purchased.

The term “links to online platforms” refers to electronic references, such as URLs, deep links, or other identifiers, that, when selected or activated by a user, cause a client device to access a corresponding page or interface of an online platform where a related product can be viewed or purchased.

The term “user” refers to any person or entity that operates or interacts with the system, including but not limited to a consumer, interior designer, property owner, or commercial operator, who provides inputs such as images or budget information and receives outputs such as interior design proposals or purchase links.

The term “budget information” refers to data representing a monetary constraint or range specified by the user, including at least a maximum allowable total cost and optionally additional conditions such as category-wise budgets, currency, or priority levels, which are used to control the cost of the proposed interior design.

The term “interior design proposal” refers to a design result generated at least in part by the generative AI model and the processor, which satisfies one or more conditions such as the determined category of the space and the budget information, and which may include a set of selected items, their arrangement in the space, and optionally corresponding product information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

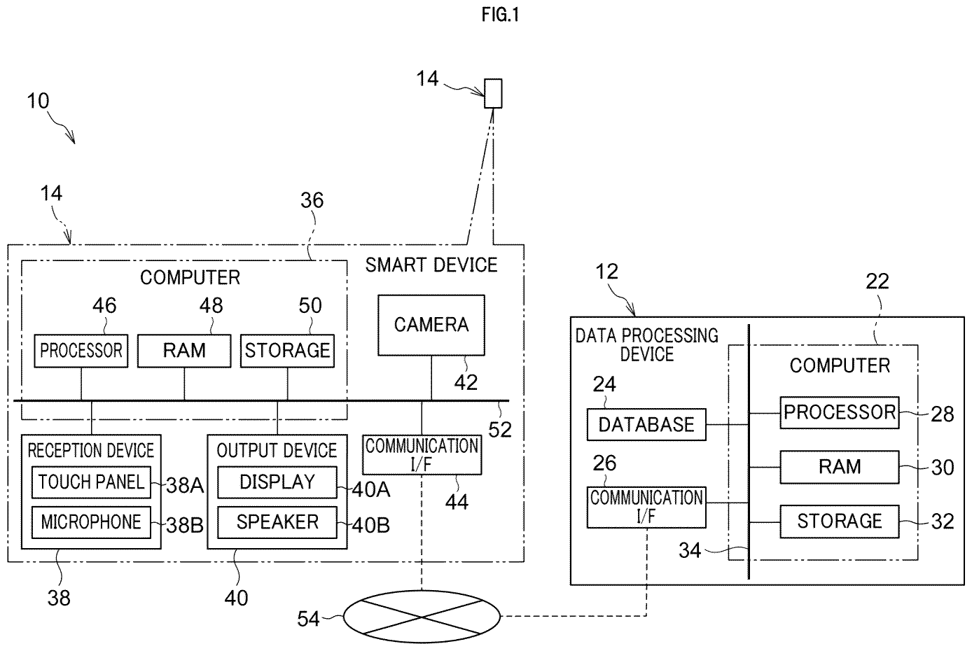

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

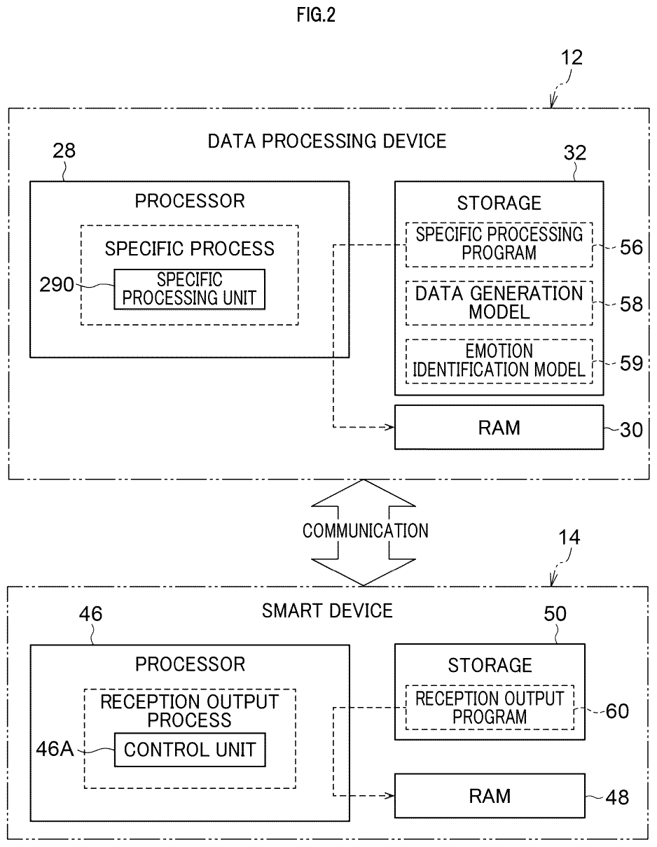

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented interior design support techniques largely rely on rule-based recommendation engines or static image libraries. In such techniques, a server typically receives a user-selected style label or a small set of parameters and returns pre-stored example images or simple layout suggestions. These approaches suffer from several technical limitations.

First, existing systems generally do not perform detailed analysis of room images at the level of pixel-based structural features and color distributions. As a result, they cannot accurately categorize the actual space captured by a user device, and they fail to adapt generated images to the real configuration of the space. This leads to a technical mismatch between the captured room image and the displayed design image, which in turn reduces the utility of the system and requires repeated manual trial-and-error by the user.

Second, in many systems, generative AI models are used in a naive manner, where the server simply forwards a user-entered text description as a prompt to the model. Such direct use of user text fails to leverage machine-derived information about the actual space, such as structural elements, interior components, and color schemes. Consequently, the generative AI model often produces images that do not correspond to the physical constraints or visual characteristics of the user's room, which degrades the effectiveness of the computing resources consumed for generation.

Third, conventional systems do not integrate cost constraint information into the technical pipeline of image analysis, category determination, interior planning, and prompt construction. Cost constraints are often handled only at a post-processing or filtering stage, separate from the generation of interior design images. This separation results in inefficiencies such as generating designs that must later be rejected or substantially modified due to budget limitations, thereby wasting processing cycles and network resources.

Fourth, existing infrastructures for linking generated interior images to electronic commerce environments tend to rely on manual tagging or coarse-grained metadata. These mechanisms do not systematically analyze object regions in the generated images to associate them with structured article information. As a result, the server cannot programmatically derive robust links to purchasable items from the visual output, and the user cannot seamlessly transition from design visualization to product selection within a single integrated computational workflow.

Accordingly, there is a need for a computer-implemented technique that improves the functioning of a server and associated processors by: (i) automatically extracting structural and color feature information from room images; (ii) determining space categories through a trained identification model; (iii) generating structured interior planning information from category information and user attributes; (iv) constructing rich, machine-generated prompt sentences that encode both planning and cost constraints; and (v) using such prompts to drive a generative AI model in a way that yields interior design images aligned with the analyzed room and budget, while also enabling robust, automated association with product information in an electronic commerce environment. By addressing these needs, the invention improves the efficiency, accuracy, and technical integration of image analysis, planning, generative image synthesis, and commerce linking in a networked computing system.

The specific processing by the specific processing unit 290 of the data processing device 12 in Example 1 is realized by the following means.

The present invention provides a server comprising a processor configured to acquire image data of a space from an imaging device operated by a user terminal, preprocess the image data by executing an image processing program to extract feature information of structural elements and color tones from pixel-level information, determine category information of the space by inputting the feature information into an identification model stored in a memory, generate interior planning information including interior components, color scheme information, and lighting information by combining the category information with attribute information and cost constraint information obtained from the user, generate a prompt sentence in a natural language description on the basis of the interior planning information so that the prompt sentence encodes a space type, the interior components, the color scheme information, the lighting information, and the cost constraint information, input the prompt sentence into a generative information generation model executed by the server to generate image data that visually represents a design plan corresponding to the interior planning information, analyze object regions in the generated image data to obtain article information corresponding to the object regions from a data storage device or an external information providing device, and transmit the generated image data together with reference information for an electronic commerce information providing environment, which is derived from the article information, to an output device of the user terminal. This enables the server to perform an integrated and technically improved pipeline in which feature-based room categorization, structured interior planning, cost-aware prompt sentence generation, and generative AI-based image synthesis are combined with automated object-region analysis and article linking, thereby producing design images that are more accurately adapted to the captured space and budget while reducing ineffective generations and enhancing the efficiency and utility of the computer system.

The term “image data” refers to digital data representing visual information of a space, including pixel values and any associated metadata derived from an image captured by an imaging device.

The term “space” refers to a physical environment such as a room, area, or interior region whose visual characteristics are captured in the image data.

The term “imaging device” refers to an apparatus configured to capture visual information of a space and output corresponding image data, including, for example, a camera, a portable terminal equipped with a camera, or any other image acquisition device.

The term “image processing program” refers to software instructions executed by a processor to perform operations on image data, including preprocessing, feature extraction, transformation, or analysis based on pixel-level information.

The term “pixel information” refers to numerical values associated with individual picture elements of image data, including color components, brightness, and any derived measurements used in image analysis.

The term “feature information” refers to data representing characteristics of a space obtained from image data, including, for example, structural elements, contours, shapes, textures, and color distributions.

The term “structural elements” refers to components of a space that define its physical configuration, including, for example, walls, floors, ceilings, windows, doors, and large fixed or semi-fixed objects.

The term “color tones” refers to characteristics of colors present in the image data of a space, including hue, saturation, brightness, and their distributions across the image.

The term “identification model” refers to a computational model, such as a trained machine learning or statistical model, configured to receive feature information as input and output category information of a space.

The term “category information” refers to data indicating a classification of a space according to a predetermined set of categories, such as style type, usage type, or other classification attributes determined by the identification model.

The term “attribute information” refers to information obtained from a user or an external source that characterizes requirements or preferences related to an interior design, including style preferences, room type, or functional requirements.

The term “cost constraint information” refers to information indicating one or more constraints on allowable cost associated with an interior design, such as a budget upper limit, price range, or other economic condition specified by a user.

The term “interior planning information” refers to structured data representing a plan for an interior design of a space, including information about interior components, color schemes, lighting, and other layout or configuration details.

The term “interior components” refers to elements included in an interior planning information, such as furniture, fixtures, decorative items, and other items to be arranged within a space.

The term “color scheme information” refers to information defining a set of colors and their relationships to be used in an interior design, including dominant colors, accent colors, and their intended application to surfaces or objects.

The term “lighting information” refers to information defining types, positions, intensities, and characteristics of lighting to be used in an interior design, including natural and artificial light sources.

The term “template information” refers to pre-stored data structures representing example interior design configurations that can be referenced and combined to generate interior planning information.

The term “data storage device” refers to a hardware or virtual component configured to store data, including template information, article information, model parameters, and generated image data, such as a memory device, disk storage, or networked storage.

The term “prompt sentence” refers to a natural language text string generated by a processor to describe a desired visual output, the text string being formatted to be used as input for a generative information generation model.

The term “generative information generation model” refers to a computational model configured to generate new data, such as image data, in response to input information including a prompt sentence, and implemented, for example, as a generative artificial intelligence model.

The term “design plan” refers to a conceptual or practical specification of an interior configuration of a space, as represented by interior planning information and corresponding generated image data.

The term “generated image data” refers to image data produced by the generative information generation model based on a prompt sentence, representing a visual expression of a design plan.

The term “output device” refers to an apparatus configured to present information to a user, including, for example, a display unit of a terminal, a monitor, or any visual output interface capable of displaying image data.

The term “user terminal” refers to an information processing apparatus operated by a user, such as a portable terminal, a personal computer, or any computing terminal capable of capturing images, communicating with a server, and displaying image data.

The term “object region” refers to a region of generated image data that corresponds to a visually discernible object within the image, identified through image analysis or segmentation.

The term “article information” refers to data describing a purchasable item associated with an object region, including at least an identifier, name, category, and optionally price or specification information.

The term “external information providing device” refers to a system or service separate from the server, configured to provide information such as article information, including, for example, an external database server or networked information service.

The term “electronic commerce information providing environment” refers to a networked environment in which information relating to purchasable items is provided, such as an electronic marketplace, an online catalog, or a commerce platform accessible via a communication network.

The term “reference information” refers to information that enables a user to access an electronic commerce information providing environment related to article information, including, for example, a hyperlink, an identifier, or other access data.

In one embodiment, a server cooperates with one or more terminals operated by a user to implement an interior design support system. The server includes at least one processor, a memory storing programs and data structures, and a network interface. The terminal includes an imaging device, such as a built-in digital camera, a display device, and a communication module for exchanging data with the server over a network.

The terminal captures an image of a physical space, such as a living room or bedroom, by controlling the imaging device through an operating system API. The terminal converts raw sensor data into digital image data, for example in a compressed image format, and associates metadata such as resolution, orientation, and timestamp. The terminal then transmits the image data, together with user attribute information, to the server via a communication protocol such as HTTP over a packet-switched network.

The server receives the image data and attribute information and stores them in a data storage device. The server uses an image processing program, which can be implemented using a general-purpose image processing library such as an open-source computer vision library, to perform preprocessing on the received image data. The server executes operations including color space conversion, resizing to a normalized resolution (for example, 512×512 pixels), and noise reduction. The server thereby generates normalized image data that is suitable for subsequent feature extraction and classification.

The server extracts feature information from the normalized image data. The server computes low-level features such as edge maps, texture descriptors, and color histograms. For example, the server applies an edge detection algorithm to identify boundaries of structural elements and furniture, and computes histogram vectors that represent distributions of color values across the image. The server also generates high-level features using a trained neural network, such as a convolutional neural network having multiple convolutional layers, pooling layers, and fully connected layers. The server inputs the normalized image data into this neural network and obtains a feature vector from one of the intermediate layers or from the output of a penultimate layer. The server concatenates the low-level feature descriptors and the high-level feature vector into a combined feature information structure, for example a fixed-length numeric vector stored in a memory as a multi-dimensional array.

The server determines category information of the space by inputting the combined feature information into an identification model. In one example, the identification model is implemented as a neural network classifier, such as a residual network with skip connections, that has been trained to output probabilities over a plurality of interior style categories, such as modern, classic, minimalist, and other styles. During training, the server or an external training environment stores training image data and corresponding category labels, defines a loss function such as cross-entropy error between predicted probabilities and ground truth labels, and updates network weights by stochastic gradient descent or a variant such as Adam optimization. The server uses backpropagation to propagate the error through the network and adjust the weights. The server may apply data augmentation operations, such as random cropping, rotation, and color jitter, to the training images to improve robustness. As a result, the identification model achieves improved classification accuracy and generalization over diverse room images.

The server executes the identification model at inference time by loading the trained weights and performing forward propagation on the combined feature information. The server computes class probabilities and selects the category with the highest probability as category information. The server may also compute a confidence score, and may store the selected category and confidence score in a structured record associated with the corresponding image data.

The server generates interior planning information based on the category information and attribute information obtained from the user. Attribute information can include room type, style preferences, and cost constraint information indicating a maximum budget or price range. The server accesses template information stored in a data storage device, such as a relational database or a key-value store. Each template entry includes data fields that represent an example interior configuration, including interior components (such as furniture types and decorative items), color scheme information, lighting information, and estimated cost information.

The server selects one or more template entries in accordance with the category information and attribute information. In one example, the server executes a database query that filters templates by style category, room type, and cost constraint. The server may score candidate templates based on similarity between template attributes and feature information of the space, and may select a template that maximizes a scoring function subject to cost constraints. The server constructs interior planning information as a structured data object. The server may represent interior components as records having fields for type, dimensions, material, color, and approximate position; color scheme information as a list of main colors and accent colors; and lighting information as types and positions of light sources and target luminance values.

The server generates a prompt sentence in a natural language description based on the interior planning information. The server implements a prompt generator module that formats the interior planning information into a descriptive text. The prompt generator module receives the space type, selected style category, interior components, color palettes, lighting configurations, and cost constraint information as inputs and inserts them into predefined sentence templates. The server thus constructs a prompt sentence that encodes both the planned configuration and constraints, rather than relying on free-form user text. This structured generation of the prompt sentence improves consistency and allows the generative AI model to receive detailed, machine-derived conditions.

For example, when the server determines that a room belongs to a modern style category and selects interior components including a gray sofa, a light wood coffee table, white walls, and warm indirect lighting, the server may generate a prompt sentence such as:
“Please generate a realistic high-resolution image of a modern living room interior design with a gray fabric L-shaped sofa, a light oak coffee table, white walls, a large window, and warm indirect ceiling lighting, viewed from the entrance.”

When the server receives cost constraint information for a low budget bedroom, the server may generate a prompt sentence such as:
“Please generate a minimalist bedroom interior design under a low budget, with a simple wooden bed frame, plain white bedding, light gray walls, one small wooden bedside table, and soft natural daylight from a window, viewed from the doorway, in a realistic photographic style.”

The server inputs the prompt sentence into a generative AI model configured as a generative information generation model. In one embodiment, the generative AI model is implemented as a diffusion-based neural network that receives the prompt sentence as text input and iteratively generates image data by starting from random noise and applying a sequence of denoising steps. The server encodes the prompt sentence into a numeric representation using a text encoder, such as a transformer-based encoder, and feeds the encoded representation into the generative network as a conditioning signal. The generative network includes a series of convolutional or attention-based layers that operate on a latent representation of the image and update this representation according to the encoded prompt and stochastic noise schedules.

The server executes the generative AI model on a processor and, optionally, on a graphics processing unit configured to accelerate tensor operations. The server specifies generation parameters such as the number of denoising steps, guidance strength, and target resolution. The server performs the forward pass at each denoising step and updates the latent image representation according to the learned parameters and prompt conditioning. The server obtains a final latent representation and decodes it into pixel-level image data. The server thereby generates image data that visually represents the design plan corresponding to the interior planning information.

The server then analyzes object regions in the generated image data to associate visual elements with article information. The server applies an object detection or segmentation model to the generated image data. Such a model can be implemented as a convolutional neural network that outputs bounding boxes or segmentation masks for probable object classes, such as sofa, table, chair, lamp, or other interior components. The server uses feature descriptors of the detected object regions to query a product information database or an external information providing device. The server matches attributes such as object category, approximate color, and shape with stored article information records that contain identifiers, names, categories, and pricing information. The server thus creates links between abstract visual entities in the generated image and concrete items in an electronic commerce information providing environment.

The server generates reference information, such as resource locators or identifiers, for the matched articles and combines this reference information with the generated image data. The server transmits the resulting data to the terminal. The terminal receives the image data and reference information and displays the generated image on its display device. The terminal may overlay icons or interactive elements near positions corresponding to object regions, allowing the user to access article details by interacting with the display.

The user views the generated image, which is adapted to the structural features and color tones of the actual space and constrained by the specified budget. The user can interact with the terminal to inspect proposed arrangements and linked products. By using the described pipeline, the system reduces the need for the user to manually search for suitable designs and items.

The described system yields several technical effects that improve computer technology rather than merely automating human judgment. The server processes feature-rich image data and combines low-level and high-level features into a structured representation that enables more accurate and robust categorization of spaces than simple rule-based or keyword-based approaches. This reduces misclassification and thus lowers the number of iterations of image generation, decreasing computation time and network traffic. The server's use of template information and structured interior planning information, rather than directly passing user queries to a generative model, constrains the solution space before generation. This pre-planning reduces the probability that the generative model will produce images that are inconsistent with the real room or budget, thereby improving computational efficiency by avoiding unproductive generations.

The server also achieves a technical improvement in data management and communication by encoding planning and constraint information into a compact prompt sentence. Because the prompt sentence is derived from structured data and includes only necessary attributes, the server can avoid repeatedly transmitting large volumes of intermediate planning data to external generative services. This reduces communication overhead and latency in distributed deployments.

Furthermore, the integration of object region analysis on the generated image and automated retrieval of article information from storage devices or external services constitutes a non-conventional technical combination. Instead of manually annotating images or relying solely on pre-tagged assets, the server uses learned features in detection models and product attribute similarity measures to automatically map image regions to article records. This improves the accuracy and scalability of linking generated content to real-world items and reduces manual tagging work.

The system uses specific neural network architectures and training procedures that differ from conventional human-centric workflows. In the identification model, the server uses a deep network with residual connections and a defined loss function; in the generative model, the server uses a diffusion process with a schedule of noise levels and a guidance mechanism that interpolates between unconditional and conditional denoising predictions. The server applies data augmentation strategies in training the identification model and may fine-tune the generative model on example images of interiors to better match domain-specific patterns. These algorithmic techniques improve classification accuracy, stability of generation, and visual fidelity of outputs, thereby providing technical improvements inside the computer system itself.

In a variation, the server may employ alternative generative AI models, such as an autoregressive model or a generative adversarial network, provided that the model accepts prompt sentences and outputs image data. In another variation, the server may execute portions of the feature extraction or category determination on the terminal, when the terminal has sufficient computational resources, thereby reducing server load and network latency. In yet another variation, the server may store and maintain multiple sets of template information, each tuned for a different region, cultural style, or typical room dimension, and may use location or device information as additional attributes in generating interior planning information.

The server can also implement adaptive prompt generation strategies. For example, the server may adjust the level of detail in the prompt sentence based on a feedback loop that monitors generation quality. When the generated images exhibit artifacts or style mismatches, the server can modify templates or weighting rules in the prompt generator module to emphasize structural constraints or budget constraints more strongly. This adaptive behavior uses metrics computed from image analysis and user interaction logs to refine the internal representation and control logic, further improving generation efficiency and quality. By combining these elements—a structured feature representation, a trained identification model, a planning layer based on template information, a constrained prompt generation module, a generative AI model, and an object-article mapping mechanism—the system provides a unified technical solution that improves the functioning of the server and the cooperating terminals. The improvements include increased accuracy of interior category determination, more efficient use of generative computation resources, reduction of unnecessary network transmissions, and improved integration between generated visual content and structured commerce data.

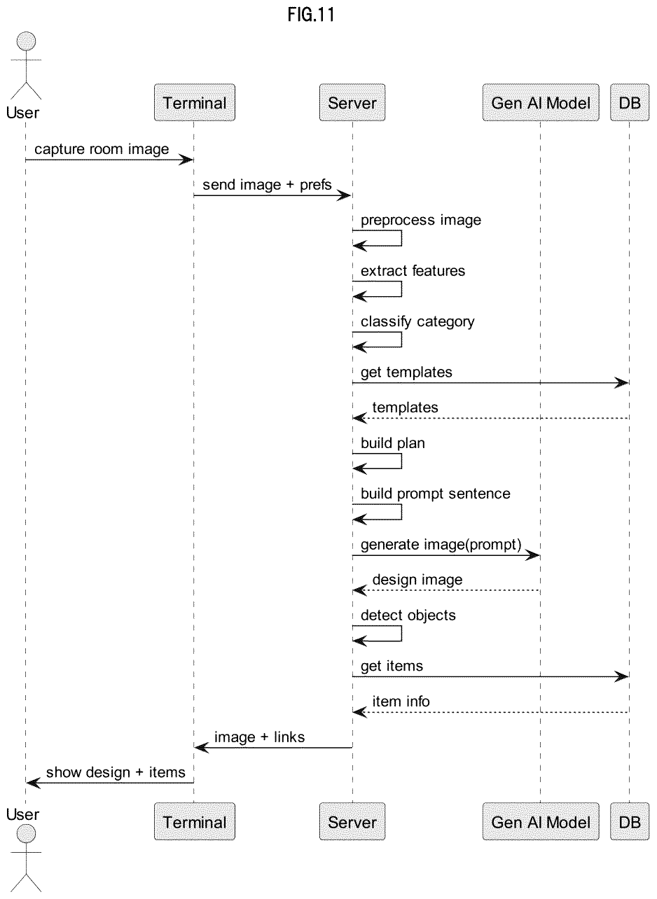

The following describes the processing flow using FIG. 11.

### Step 1:

The user operates the terminal to capture an image of a space.

The terminal activates an imaging device through an operating system interface, displays a live preview on the display, and waits for a user input such as a touch event on a capture button.

Input: a physical space and a user operation.

Output: raw image data captured from the image sensor.

The terminal converts raw sensor signals into digital image data in a standard format, attaches metadata including resolution and orientation, and stores the image data in local storage.

### Step 2:

The terminal prepares and transmits a request to the server.

Input: the stored image data and user attribute information including at least room type, style preference, and cost constraint information.

Output: a network request packet containing the image data and the attribute information.

The terminal reads the image file from local storage into memory, packages the binary data into a request body along with structured attribute fields, and sends the request through a communication module using a network protocol to a predetermined server endpoint.

### Step 3:

The server receives and stores the request data.

Input: the network request packet including image data and attribute information.

Output: stored image data and a corresponding request record in a data storage device.

The server parses the request, verifies headers and content type, writes the image data to a designated storage location, and registers a record that associates a unique request identifier with file paths and user attribute information.

### Step 4:

The server performs image preprocessing.

Input: stored image data retrieved from the data storage device.

Output: normalized image data suitable for feature extraction.

The server reads the image file into memory, converts the color space if necessary, resizes the image to a predefined resolution, and applies noise reduction and contrast adjustment by executing an image processing program.

The server thereby generates normalized pixel arrays, which are stored as in-memory data structures.

### Step 5:

The server extracts feature information from the normalized image data.

Input: normalized image data.

Output: combined feature information representing structural elements and color tones.

The server computes low-level features, such as edge maps and color histograms, by performing numerical operations on pixel arrays.

The server then inputs the normalized image data into a pre-trained convolutional neural network and performs forward propagation to obtain a high-level feature vector.

The server concatenates the low-level and high-level feature vectors into a single fixed-length feature representation and stores this representation as feature information.

### Step 6:

The server determines category information using an identification model.

Input: the combined feature information.

Output: category information including a selected category label and an associated confidence value.

The server loads parameters of the identification model from memory and executes a forward pass of the model using the feature information as input.

The server calculates class probabilities for a plurality of interior style categories, identifies the category with the highest probability, and records the category label and confidence score as category information in a structured record.

### Step 7:

The server generates interior planning information.

Input: the category information and the user attribute information including room type and cost constraint information.

Output: interior planning information specifying interior components, color scheme information, and lighting information.

The server queries a data storage device that contains template information and filters candidate templates based on the style category, room type, and cost constraints.

The server selects one or more templates and merges their data to construct a structured planning object, including entries for furniture types, approximate positions, recommended colors, and lighting types.

The server may adjust or remove components that exceed the cost constraint by computing aggregated estimated costs and comparing them with the cost constraint information.

### Step 8:

The server generates a prompt sentence in a natural language description.

Input: the interior planning information and the cost constraint information.

Output: a prompt sentence formatted for a generative AI model.

The server passes elements of the planning information, such as style category, interior components, color scheme, and lighting configuration, into a prompt generator module.

The server inserts these elements into a sentence template and appends a textual expression of the cost constraint.

For example, the server may generate a prompt sentence such as:
“Please generate a realistic high-resolution image of a modern living room interior design with a gray fabric L-shaped sofa, a light oak coffee table, white walls, a large window, and warm indirect ceiling lighting, viewed from the entrance.”

Or, when a low budget is specified, the server may generate:
“Please generate a minimalist bedroom interior design under a low budget, with a simple wooden bed frame, plain white bedding, light gray walls, one small wooden bedside table, and soft natural daylight from a window, viewed from the doorway, in a realistic photographic style.”

The server stores the generated prompt sentence as text associated with the request.

### Step 9:

The server generates image data using a generative AI model.

Input: the prompt sentence and generation parameters such as resolution and number of inference steps.

Output: generated image data representing a design plan corresponding to the interior planning information.

The server encodes the prompt sentence into a numerical vector using a text encoder and supplies this vector as a condition to a generative AI model, such as a diffusion-based generative information generation model.

The server initializes a latent representation or noise array and repeatedly applies denoising operations parameterized by learned model weights, while conditioning on the encoded prompt vector.

The server executes these numerical operations on a processor, and optionally on a graphics processing unit, until a final latent representation is obtained and decoded into pixel-level image data.

The server writes the generated image data to the data storage device and registers a reference in the request record.

### Step 10:

The server analyzes object regions in the generated image data.

Input: the generated image data.

Output: object region information and associated article candidates.

The server applies an object detection or segmentation model to the generated image data.

The server computes bounding boxes or segmentation masks for detected objects and assigns object categories such as sofa, table, chair, or lamp.

The server then uses these categories and visual attributes extracted from the corresponding regions to search a product information database or request information from an external information providing device.

The server obtains article records that match each detected object category and stores these associations as object region information linked to article candidates.

### Step 11:

The server generates reference information for an electronic commerce information providing environment.

Input: the object region information and associated article candidates.

Output: reference information including access data for purchasable items.

The server selects article records according to predetermined criteria, such as similarity score and price compatibility with the cost constraint information.

The server extracts identifiers or network resource locators for the selected articles and composes reference information that maps object regions to corresponding item access data.

The server stores this reference information together with the generated image data.

### Step 12:

The server transmits the generated results to the terminal.

Input: the generated image data, the prompt sentence, the category information, and the reference information.

Output: a response message transmitted to the terminal.

The server formats a response containing the image data or a link to the stored image, along with metadata including the category label, the prompt sentence that was used for the generative AI model, and the reference information for purchasable articles.

The server sends this response through the network interface to the terminal that issued the original request.

### Step 13:

The terminal receives and displays the generated image and related information.

Input: the response message from the server containing the image data and metadata.

Output: a display of the generated interior design image and optionally interactive elements linked to article information.

The terminal decodes the image data or retrieves the image from the provided link, renders the image on the display, and may show the category label and the prompt sentence as textual information.

The terminal overlays icons or interactive markers corresponding to object regions and associates these markers with the reference information so that user interaction can reveal item details.

### Step 14:

The user interacts with the terminal to review and refine the design.

Input: the displayed image, the interactive elements, and user operations such as taps or selections.

Output: updated user attribute information or new requests to the server.

The user examines the generated design, inspects linked article details if desired, and may adjust preferences such as style category, cost constraint, or specific interior components.

The terminal records these adjustments as updated attribute information and, when requested by the user, initiates a new request to the server, thereby repeating the processing flow with refined input conditions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented interior planning systems generally rely on rule-based configuration engines or static template libraries. Such systems require engineers or designers to predefine a limited set of patterns and mappings between room categories, interior styles, and purchasable items. As a result, the systems are unable to flexibly adapt to diverse room geometries, mixed lighting conditions, or nuanced user preferences, and they often produce generic proposals that do not adequately reflect the specific context of an individual space. Moreover, when generative AI models are used in a naïve manner, the models are typically invoked with manually written prompts that are disconnected from structured image analysis, product databases, and user budget constraints, leading to inconsistent quality and poor controllability of the generated interior designs.

From a computer technology perspective, there is no integrated mechanism in the conventional systems for (i) automatically converting image-derived room feature data and user condition data into a structured, machine-generated prompt sentence, (ii) tightly coupling a generative AI model with downstream product-matching computations and budget-constrained optimization algorithms, and (iii) iteratively refining both the generative prompt and the resulting product combinations based on user feedback while maintaining traceability between generated visual content and underlying structured data. In addition, conventional systems do not provide a unified data processing pipeline that can automatically derive, from a single source of room image data, both high-level interior plans and concrete, verifiable purchasing and facility-guidance information in a manner that is computationally efficient and suitable for large-scale deployment.

Accordingly, there is a need for an improved computer-implemented technique that transforms raw image data of a space and user condition data into machine-usable feature data, generates and refines prompt sentences for a generative AI model under explicit budget and style constraints, and integrates the generative output with database-backed product selection, combination optimization, and facility-guidance generation. Such a technique should improve the functioning of the computer system itself by providing a structured, automated, and closed-loop workflow that reduces manual intervention, improves consistency and relevance of generated proposals, and enables efficient, data-driven refinement and delivery of interior design proposals to user terminals.

The specific processing by the specific processing unit 290 of the data processing device 12 in Application Example 1 is realized by the following means.

The present invention provides a server comprising a processor configured to receive, from a terminal including an imaging device, image data of a space and user condition data including preference information and budget information; to perform preprocessing on the image data of the space by using an image processing program to generate input data for feature extraction; to input the input data for feature extraction into a machine learning program to calculate feature amount data of the space and determine, based on the feature amount data and the user condition data, a category of the space and an interior style category; to generate a prompt sentence as a descriptive text including at least the category of the space, the interior style category, the feature amount data of the space, and the budget information; to input the prompt sentence and the image data of the space into a generative information generation program that is a generative AI model so as to cause the generative information generation program to generate visual representation data of an interior design suitable for the space; to analyze the visual representation data of the interior design by using an image recognition program to specify article elements included in the visual representation data and to generate attribute information data for each of the article elements; to compare the attribute information data with product information data stored in a product information storage device so as to select a plurality of candidate products corresponding to the interior design, and calculate product combinations such that a total amount for each interior plan obtained by combining the candidate products falls within the budget information; to generate proposal information data for each interior plan, the proposal information data including information of the candidate products, the visual representation data of the interior design, the prompt sentence used for generation of the visual representation data, and guidance information on facilities at which the candidate products are actually confirmable; to transmit the proposal information data to the terminal; and to, in response to evaluation information data received from the terminal, update contents of the prompt sentence and re-input a revised prompt sentence together with the image data of the space into the generative information generation program to generate revised visual representation data and corresponding candidate product information reflecting the evaluation information data. This enables an integrated, computer-implemented workflow in which raw image data and user condition data are automatically transformed into structured prompt sentences, generative AI outputs, optimized product combinations, and facility-guidance information, thereby improving the operation of the server by reducing manual prompt engineering, ensuring budget-consistent and style-consistent interior proposals, and supporting iterative refinement based on user feedback within a single, coherent data processing pipeline.

The term “space” refers to a physical environment such as a room, area, or interior region that is captured in an image and is a target for interior design planning.

The term “terminal” refers to an information processing apparatus, such as a portable computing device or stationary computing device, that includes an imaging device and is configured to capture image data of a space and communicate with a server.

The term “imaging device” refers to hardware, such as a camera module or image sensor system, configured to optically capture a scene of a space and output corresponding digital image data.

The term “image data” refers to digital information representing a captured image of a space, including pixel values or encoded image files that can be processed by an image processing program.

The term “user condition data” refers to structured information provided by a user, including at least preference information and budget information, that is used to control or constrain interior design generation and product selection.

The term “preference information” refers to data indicating a user's desired characteristics of an interior design, such as target room type, interior style category, color scheme, functional requirements, or other stylistic or practical preferences.

The term “budget information” refers to data indicating a monetary limit or range within which the total cost of one or more interior plans, including candidate products, is constrained.

The term “image processing program” refers to software or firmware configured to perform processing on image data, such as resizing, normalization, format conversion, or other preprocessing operations to generate input data for feature extraction.

The term “input data for feature extraction” refers to processed image data that has been transformed by an image processing program into a format suitable for input to a machine learning program for extraction of feature amount data.

The term “machine learning program” refers to software implementing a learned model, such as a neural network or other statistical model, configured to receive input data for feature extraction and output feature amount data representing characteristics of a space.

The term “feature amount data” refers to numerical or symbolic data representing extracted features of a space, such as layout, color distribution, presence of objects, or other attributes derived from image data.

The term “category of the space” refers to a classification label assigned to a space, such as room type or usage category, determined on the basis of feature amount data and optionally user condition data.

The term “interior style category” refers to a classification label indicating an interior design style, such as a stylistic concept or design genre, determined on the basis of feature amount data and user condition data.

The term “prompt sentence” refers to a descriptive text, typically in natural language, generated automatically by the processor, that encodes at least the category of the space, the interior style category, the feature amount data, and the budget information, and is used as input to a generative information generation program.

The term “generative information generation program” refers to software implementing a generative AI model configured to receive a prompt sentence and optionally image data of a space and to output generated information, including at least visual representation data of an interior design.

The term “generative AI model” refers to a machine learning model configured to generate new data, such as images or other content, from input data including prompt sentences and image data, using learned statistical relationships.

The term “visual representation data” refers to digital information representing a generated visual depiction of an interior design for a space, such as one or more images or image-like data structures output by a generative AI model.

The term “image recognition program” refers to software configured to analyze visual representation data or other image data and to identify, localize, or classify article elements or other objects within the images.

The term “article elements” refers to visual components within visual representation data that correspond to items of furniture, fixtures, decorations, or other physical goods that can be associated with product information.

The term “attribute information data” refers to structured data describing characteristics of article elements, such as item type, color, material, shape, size, or style attributes, derived from analysis of visual representation data.

The term “product information storage device” refers to a storage apparatus, such as a database system or memory system, that stores product information data for a plurality of products.

The term “product information data” refers to information associated with products, including at least product identifiers, categories, prices, attributes, and availability, which is used to select candidate products corresponding to article elements.

The term “candidate products” refers to products selected from product information data as being suitable to correspond to article elements in an interior design and to be included in one or more interior plans.

The term “interior plan” refers to a combination of candidate products and an associated interior design configuration, the combination being evaluated with respect to budget information and other constraints.

The term “proposal information data” refers to aggregated structured data for an interior plan, including information of candidate products, visual representation data of the interior design, the prompt sentence used for generation of the visual representation data, and guidance information on facilities at which the candidate products are confirmable.

The term “guidance information” refers to information indicating facilities, locations, or channels where candidate products can be confirmed or obtained, including at least identification information and access or route information for such facilities.

The term “facility information storage device” refers to a storage apparatus that stores information relating to facilities, such as stores or showrooms, that handle candidate products.

The term “facility information” refers to data describing facilities, including at least facility identifiers, addresses, and position information data, and optionally product handling information.

The term “position information data” refers to location-related data, such as coordinates or geographic identifiers, associated with a user or a facility and used to calculate distances or routes.

The term “route guidance information” refers to data describing a path or method for a user to travel from a location associated with the user to a facility where candidate products are confirmable.

The term “evaluation information data” refers to structured feedback data received from a user, including indications of preferences, likes, dislikes, or modification requests relating to interior designs or candidate products.

The term “revised prompt sentence” refers to a prompt sentence whose contents have been updated based on evaluation information data and optionally attribute information data, and which is re-input to the generative information generation program for refined generation of visual representation data.

In one embodiment, the system includes a server, one or more terminals, and one or more storage devices interconnected via a communication network. The terminal is, for example, a smartphone, a tablet computer, or a desktop computer including an imaging device such as a digital camera module, a display, a communication interface, and a local storage device. The server is, for example, a computer system such as a physical server or a virtual machine running on a cloud platform. The server includes at least one central processing unit (CPU), optionally a graphics processing unit (GPU), a main memory, a network interface, and a non-volatile storage device. The storage devices include at least a product information storage device and a facility information storage device implemented as one or more database systems.

The terminal executes an application program that provides a user interface for interior design generation. The terminal uses an operating system such as a general-purpose mobile or desktop operating system. The terminal controls the imaging device through a camera application programming interface (API) and obtains digital image data of a space such as a room. The terminal stores the image data in a file system in a format such as JPEG or PNG and associates metadata, including capture time and optional sensor information, with the image data.

The user operates the terminal and provides user condition data including preference information and budget information through a graphical user interface. The user selects, for example, room type, preferred interior style labels, color preferences, and functional requirements. The user also inputs a target budget or a budget range. The terminal converts the user inputs into structured data, for example as key-value pairs in an internal data structure, and associates the user condition data with the captured image data.

The terminal transmits the image data and the user condition data to the server via a communication network. The terminal uses a secure communication protocol such as HTTPS and sends the data to a predetermined application programming interface endpoint provided by the server. The terminal receives response data from the server and renders visual representation data and associated product information on the display by using user interface components of the operating system.

The server executes an application program that is configured to perform image preprocessing, feature extraction, interior style determination, prompt sentence generation, generative AI model invocation, image recognition on generated images, product matching, combination optimization, and facility guidance generation. The server uses an image processing software library such as an image manipulation library to perform basic operations like resizing, cropping, and normalization on the received image data. The server converts the image data into a numerical tensor representation suitable for input to a machine learning program.

The server uses a machine learning program implemented in a framework such as a deep learning framework including a convolutional neural network (CNN) model. The server loads trained parameters of the CNN model from a model storage area and performs forward propagation on the tensor representation of the image data. The CNN model includes multiple convolutional layers, non-linear activation layers, pooling layers, and fully connected layers. The server extracts feature amount data that represents spatial layouts, dominant color distributions, estimated object categories (such as seating, tables, storage units, and lighting fixtures), and structural features such as the existence and orientation of windows and doors. The server determines a category of the space and an interior style category based on the feature amount data and the user condition data. The server uses a classification module implemented as a machine learning classifier or a rule-based module. In one example, the server uses a fully connected neural network trained to map the feature amount data to a room category label with a softmax output layer. The server further uses a style selection module that computes similarity scores between the feature amount data, the user preferences, and pre-defined style profiles stored in a style profile database. The server defines each style profile as a vector of attributes including typical color palettes, furniture density, material preferences, and lighting patterns. The server calculates a distance metric between the feature amount data and each style profile, and selects one or more interior style categories having minimum distance or highest similarity scores.

The server generates a prompt sentence as a descriptive natural language text including the category of the space, the interior style category, the feature amount data summarized in human-readable form, and the budget information. The server constructs the prompt sentence by concatenating template phrases with values derived from structured data. For example, the server generates an initial prompt sentence such as:
“The user wants a modern living room interior proposal. Please generate an interior design image based on the following room photo. The room is a medium-sized living room with white walls, wooden flooring, a large window on the left, and existing basic furniture. Use a modern style with simple lines, neutral colors, and one blue accent color. Keep the layout practical for a family with two children. Room photo is attached below.”

In another example, when the budget information is emphasized, the server generates a prompt sentence such as:
“The user wants a Scandinavian-style living room interior proposal with a total furniture budget under 150,000 yen. Please generate an interior design image based on the following room photo. The room is a small apartment living room with light-colored walls and limited floor space. Use light wood, white and gray tones, compact and functional furniture, and minimal decorative items while staying within a low to mid-range budget. Room photo is attached below.”

In a further example, when refinement based on user feedback is required, the server generates a revised prompt sentence such as:
“The user liked the previous modern living room proposal but requests warmer lighting, more natural wood textures, and additional indoor plants. Please generate an updated interior design image based on the same room photo, keeping the modern style but adding warm ambient lighting, wooden furniture, a wooden coffee table, and several green plants near the window. Room photo is attached below.”

The server inputs the prompt sentence and the image data of the space into a generative information generation program that is a generative AI model. The server uses a generative model of the image generation type that combines a text encoder and an image decoder. The server sends the prompt sentence and, in some embodiments, the original room image as a conditioning input to a model inference API. The model includes a transformer-based text encoder, a latent representation module, and a decoder such as a diffusion-based image synthesis network or an auto-regressive image generation network. The server receives as output one or more sets of visual representation data, each set including digital image data depicting an interior design applied to the space.

The server analyzes the generated visual representation data by using an image recognition program implemented as an object detection or semantic segmentation model. The server uses, for example, a region-based convolutional neural network or a single-shot detector that outputs bounding boxes and category labels for detected article elements. The server generates attribute information data for each article element, including attributes such as furniture category, approximate color in a color space, estimated material, and approximate size relative to other elements. The server stores the attribute information data in association with the corresponding generated image in a database.

The server compares the attribute information data with product information data stored in the product information storage device. The server uses a database management system and a similarity matching algorithm to map the attribute information data to candidate products. In one embodiment, the server represents each product entry as a feature vector containing standardized attributes such as category, color encoding, material encoding, and size parameters. The server computes similarity scores between the attribute information data and the product feature vectors using a metric such as cosine similarity or Euclidean distance. The server selects a plurality of candidate products whose similarity scores exceed a predetermined threshold.

The server computes product combinations for forming interior plans. The server maintains the budget information as a constraint and performs a combinatorial optimization. For example, the server formulates the product selection problem as a constrained optimization problem where decision variables represent whether each candidate product is included, the objective is to maximize a style and attribute consistency score, and the constraint is that the sum of prices is equal to or less than the budget. The server uses an algorithm such as a dynamic programming method, a greedy heuristic, or a mixed-integer linear programming solver to compute feasible product combinations efficiently. The server thereby generates one or more interior plans that each combine candidate products in a manner that satisfies the budget and maintains consistency with the generated interior design.

The server generates proposal information data for each interior plan. The proposal information data includes, for example, identifiers of the candidate products, detailed product attributes, price information, the associated visual representation data of the interior design, and the prompt sentence used for generating the visual representation data. The server also generates guidance information based on facility information stored in a facility information storage device. The server identifies facilities that handle the candidate products by matching product identifiers with facility inventory records. The server uses position information data, such as global positioning coordinates of the user's location and stored facility coordinates, to compute distances and to derive route guidance information. The server includes the facility names, addresses, and access routes in the proposal information data.

The server transmits the proposal information data to the terminal. The terminal decodes the received data and displays the visual representation data as images on the display along with lists of candidate products and facility guidance information. The user views the images and product lists and can evaluate how well the proposed interior design matches the actual space and preferences.

The user provides evaluation information data through the terminal by, for example, tapping buttons or entering text indicating likes, dislikes, or desired modifications of specific elements. The terminal structures this evaluation information data and sends it back to the server. The server receives the evaluation information data and updates the contents of the prompt sentence accordingly. The server modifies, for example, the descriptive language specifying colors, materials, furniture density, or lighting conditions. The server generates a revised prompt sentence that integrates the user feedback into the previously determined room category, interior style category, feature amount data, and budget information. The server then re-inputs the revised prompt sentence and the image data of the space into the generative AI model and obtains revised visual representation data and updated attribute information data and candidate product lists. In this way, the server constructs a closed-loop refinement process that iteratively converges to proposals that better align with the user's evaluation.

From a technical standpoint, the server improves computer technology in several ways. The server uses a specific data structure design in which raw image data, feature amount data, style profiles, prompt sentences, generated images, attribute information data, and product information data are linked by identifiers and stored in relational or document-oriented databases. This structured linkage enables traceability from a generated image back to low-level features and user inputs, which allows the server to perform targeted modifications to the prompt sentence and to the interior plan without regenerating all intermediate data. As a result, the server reduces redundant computation and improves processing speed when refining proposals.

The server's use of machine learning programs and generative AI models goes beyond simple automation of human design tasks. The CNN-based feature extraction compresses high-dimensional image data into compact feature amount data that the server can process efficiently, thereby reducing memory footprint and network bandwidth. The generative AI model receives prompt sentences that are automatically synthesized from structured data, using an internal representation more precise and more detailed than ad hoc human-written prompts. This improves the determinism and repeatability of model outputs and enables the server to systematically steer the generative AI model to satisfy budget and style constraints.

The server uses a training procedure for the underlying neural networks that includes supervised learning on large annotated datasets of interior images and room categories. The server (during an offline training phase) applies a loss function such as cross-entropy for classification outputs and mean squared error for regression outputs such as size or color estimation. The server updates the weights of the neural network models by gradient descent with an optimizer such as stochastic gradient descent with momentum or an adaptive optimizer. The server applies data augmentation methods such as random cropping, rotation, scaling, and color jittering to increase robustness against variations in captured images. By training in this manner, the server deploys a model that exhibits high accuracy in recognizing room features and article elements, which directly contributes to the technical effect of improved mapping between visual representation data and product information.

The generative AI model used by the server is trained with a combination of paired image-text data. The model uses a text encoder that converts tokenized prompt sentences into an embedding vector and an image decoder that generates images by iteratively sampling from a latent distribution. The training procedure includes minimizing a loss function that compares generated images with target images or a noised version of target images, and weight updates are applied using gradient-based optimization algorithms. This training results in a generative model that can accurately render complex interior structures and lighting conditions based on the structured prompt sentences synthesized by the server.

The server further improves communication efficiency by transmitting compressed images and structured JSON-like payloads that encapsulate only identifiers and necessary attributes rather than entire raw datasets. For instance, when the server transmits proposal information data to the terminal, the server sends references to product images rather than raw image feature vectors. This design reduces network bandwidth usage and improves responsiveness. The server may also cache intermediate results, such as feature amount data and style selections, so that when the user modifies only a portion of the preferences, the server reuses existing computations and avoids re-running the entire pipeline.

The described configuration differs from mere computerization of a human workflow. Human designers manually observe a space, mentally infer features, select styles, search for products, and compose a design, whereas the server uses formalized feature vectors, trained mappings, and optimization algorithms that operate at machine speed on high-dimensional data. The server's decision rules, such as similarity metrics in feature space and budget-constrained combination optimization, are executed numerically and are not based on heuristic textual reasoning typical of human work. These rules are integrated with generative AI and image recognition modules in a non-conventional sequence and with bidirectional feedback via revised prompt sentences.

In alternative embodiments, the server uses different neural network architectures, such as a vision transformer for feature extraction or a graph neural network for modeling relationships between furniture items in a layout graph. The server may also use different optimization strategies, such as evolutionary algorithms to propose diverse interior plans. The terminal may be implemented as an augmented reality device that overlays generated interior designs onto a live camera feed, and the server may adapt the prompt sentence to account for real-time sensor data such as depth information or illumination measurements.

In another embodiment, the server aggregates anonymized user feedback over many sessions and uses the aggregated evaluation information data to re-train or fine-tune the style selection module and prompt generation rules. The server thereby improves its accuracy in predicting which interior styles and product combinations are likely to be accepted by users, further enhancing computational efficiency by reducing the number of refinement cycles necessary for future users.

Because the server implements specific data structures, neural network architectures, training methods, and optimization algorithms that are tightly integrated with image capture and display operations of the terminal, the overall system improves processing speed, accuracy of interior recognition and product matching, and efficiency of network communication. These technical effects arise from the particular configuration and cooperation of the server, the terminal, and the storage devices, rather than from an abstract idea or a generic business logic alone.

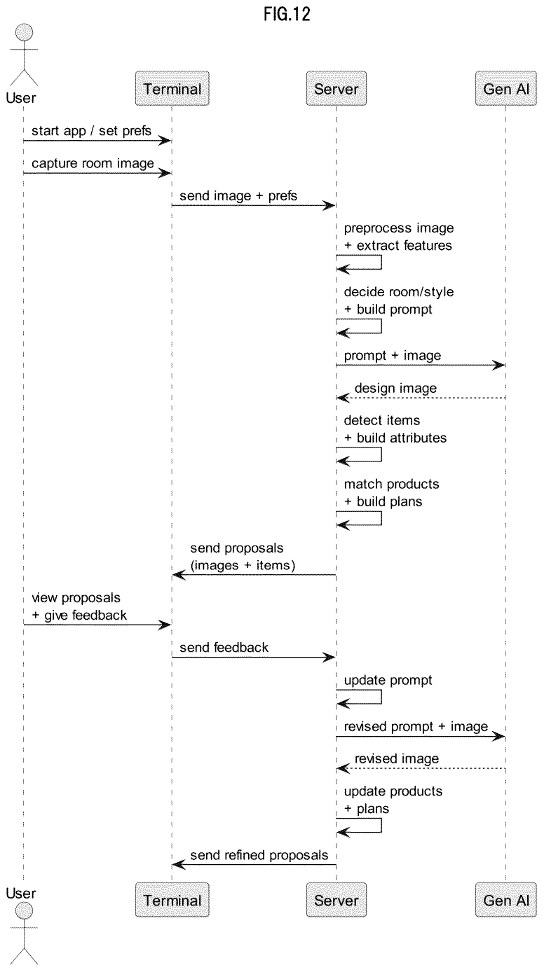

The following describes the processing flow using FIG. 12.

### Step 1:

The user operates the terminal to launch an interior design application and set initial conditions. The user selects a room type, preferred interior style labels, and a budget amount via the graphical user interface of the terminal.

Input: User actions on UI components (touch events, text inputs).

Processing: The terminal converts these actions into structured user condition data (for example, key-value pairs representing room type, style preference, budget, and other constraints) and stores this data in local memory.

Output: Structured user condition data stored on the terminal.

### Step 2:

The user uses the terminal to capture at least one image of the target space. The user points the imaging device toward the room and presses a shutter control in the application.

Input: Control signals from the user and raw sensor data from the imaging device.

Processing: The terminal controls the imaging device through an operating system API, receives raw image frames, encodes the frames into a digital image file (for example, JPEG), and associates metadata such as timestamp and orientation.

Output: Encoded image data of the space stored in the terminal's file system.

### Step 3:

The terminal prepares a transmission payload containing the image data and the user condition data.

Input: Encoded image data and structured user condition data.

Processing: The terminal reads the image file from storage, converts the image into binary or base 64 representation if necessary, and combines this with the user condition data into a structured message (for example, a JSON object with a multipart body).

Output: A structured request payload ready to be sent to the server.

### Step 4:

The terminal transmits the request payload to the server via a communication network.

Input: Structured request payload and an API endpoint URL.

Processing: The terminal establishes an HTTPS connection, sets HTTP headers, serializes the payload, and sends an HTTP POST request to the server. The terminal then waits for a response and may display a loading indicator to the user.

Output: A network message containing image data and user condition data received by the server.

### Step 5:

The server receives and parses the request from the terminal.

Input: HTTP request containing the payload with image data and user condition data.

Processing: The server's web application framework parses the HTTP headers and body, extracts the image data and user condition data, verifies integrity (for example, checksum, size limits), and assigns an internal job identifier. The server stores temporary references to the received data in a session store or database.

Output: Validated image data and user condition data stored on the server with an associated job ID.

### Step 6:

The server performs image preprocessing to create input data for feature extraction.

Input: Raw image data associated with the job ID.

Processing: The server loads the image into an image processing library, resizes the image to a predefined resolution, normalizes pixel values (for example, scaling to [0,1] or mean-variance normalization), and converts the image into a multi-dimensional tensor format compatible with a machine learning framework. The server may also correct orientation and crop unnecessary margins.

Output: Preprocessed image tensor stored as input data for feature extraction.

### Step 7:

The server performs feature extraction using a machine learning program.

Input: Preprocessed image tensor.

Processing: The server loads a trained convolutional neural network model and performs forward propagation on the input tensor. The server calculates intermediate activations in convolutional layers, pooling layers, and fully connected layers, then aggregates them into feature amount data representing room geometry, object presence, color distribution, and structural cues.

Output: Feature amount data representing characteristics of the space.

### Step 8:

The server determines a category of the space and an interior style category.

Input: Feature amount data and user condition data (including room type preference and style preference).

Processing: The server applies a classification module that takes the feature amount data and outputs a room category label using a classifier (for example, a softmax layer). The server then accesses a style profile database and computes similarity scores between the feature amount data plus user style preferences and multiple predefined interior style profiles using a distance metric. The server selects one or more interior style categories corresponding to the highest similarity scores.

Output: Determined room category and selected interior style category stored with the job ID.

### Step 9:

The server generates a prompt sentence for a generative AI model.

Input: Room category, interior style category, feature amount data, and budget information from the user condition data.

Processing: The server converts numerical and categorical features into human-readable descriptors (for example, “medium-sized room,” “white walls,” “wooden flooring,” “large window on left side”) and inserts these descriptors, the chosen style name, and the budget constraint into a textual template. The server concatenates these pieces into a coherent natural language prompt sentence.

Output: A prompt sentence in text form associated with the job ID.

### Step 10:

The server prepares and sends a request to the generative AI model.

Input: Prompt sentence and, optionally, the original image data of the space.

Processing: The server constructs a model request payload including the prompt sentence, a reference to the image (binary or URL), and configuration parameters such as output resolution and number of image variants. The server then sends this payload via HTTPS to a model inference endpoint implemented by the generative AI model provider.

Output: A model inference request delivered to the generative AI model service.

### Step 11:

The server receives visual representation data generated by the generative AI model.

Input: API response from the generative AI model service containing generated images.

Processing: The server parses the response, decodes image data (for example, from base 64 to binary), and stores the generated images in a storage system. The server performs validation checks such as verifying image dimensions and file integrity.

Output: One or more generated interior design images (visual representation data) linked to the job ID.

### Step 12:

The server performs optional post-processing on the generated images.

Input: Visual representation data of the interior design.

Processing: The server uses an image processing library to resize images to terminal-appropriate resolutions, compress file sizes, and optionally create composite views (for example, before/after comparisons). The server may also embed watermarks or labels such as proposal identifiers.

Output: Optimized visual representation data ready for analysis and transmission.

### Step 13:

The server analyzes the generated images to detect article elements.

Input: Optimized visual representation data.

Processing: The server uses an image recognition program (for example, an object detection network) to process each generated image and output bounding boxes, labels, and confidence scores for detected objects. The server then aggregates this information to identify article elements such as sofas, tables, lamps, rugs, and shelves.

Output: A set of detected article elements with locations and categories for each generated image.

### Step 14:

The server generates attribute information data for each article element.

Input: Detected article elements with labels and image regions.

Processing: The server analyzes each region corresponding to an article element. The server calculates color histograms or dominant color codes, estimates shape and size from bounding box dimensions, and infers material type based on trained classifiers. The server records these attributes into structured data records for each article element.

Output: Attribute information data describing each article element.

### Step 15:

The server matches attribute information data with product information data.

Input: Attribute information data and product information data from a product information storage device.

Processing: The server represents each product in the database as a feature vector and computes similarity scores between attribute vectors of article elements and product feature vectors using a similarity metric. The server filters products based on category, price range consistent with the budget, and availability, then ranks them by similarity score.

Output: For each article element, a list of candidate products that are similar in category, color, material, and size.

### Step 16:

The server computes interior plans as combinations of candidate products under budget constraints.

Input: Candidate product lists and budget information.

Processing: The server formulates a combinatorial optimization problem where each decision variable indicates selection of a product for a given article element. The server calculates the sum of product prices and ensures that each combination stays within the user's budget. The server uses an optimization algorithm (for example, dynamic programming or mixed-integer linear programming) to find one or more optimal or near-optimal combinations maximizing a style-consistency or similarity score.

Output: One or more interior plans, each comprising a set of candidate products and a total cost compliant with the budget.

### Step 17:

The server generates proposal information data for each interior plan.

Input: Interior plans, visual representation data, prompt sentence, and product metadata.

Processing: The server assembles, for each plan, a structured data record containing identifiers and detailed information of candidate products, associated images of the generated interior design, and the prompt sentence used by the generative AI model. The server attaches additional metadata such as total price, style name, and confidence indicators.

Output: Proposal information data records corresponding to each interior plan.

### Step 18:

The server generates facility guidance information associated with candidate products.

Input: Candidate products in the interior plans and facility information data from a facility information storage device.

Processing: The server queries facility information to determine which facilities stock each candidate product. The server retrieves facility locations and uses user position information (if available) to compute distances or travel times. The server then creates route guidance data, including facility addresses and recommended paths, and incorporates this data into the proposal information.

Output: Enhanced proposal information data including facility guidance information.

### Step 19:

The server transmits proposal information data to the terminal.

Input: Complete proposal information data including images, product lists, and facility guidance.

Processing: The server serializes the proposal information data into a response format such as JSON and attaches image data or image URLs. The server sends the response via HTTPS to the terminal.

Output: A response message delivered to the terminal containing proposal information for display.

### Step 20:

The terminal receives and renders the proposal information data.

Input: Response message from the server.

Processing: The terminal parses the structured data, downloads images if referenced by URLs, and stores temporary copies in local cache. The terminal constructs user interface screens that display generated images, associated product lists, prices, and facility guidance. The terminal presents interactive controls (for example, buttons to like or dislike proposals, filters, and detail views).

Output: Displayed interior design proposals and interactive UI elements available to the user.

### Step 21:

The user evaluates the proposals and provides feedback.

Input: Displayed visual representation data, product lists, and facility information.

Processing: The user inspects images and product details, then provides evaluation information data by tapping like/dislike buttons, selecting preferred items, or entering text comments specifying desired changes (for example, “brighter colors” or “more storage”).

Output: User feedback captured as structured evaluation information data on the terminal.

### Step 22:

The terminal transmits evaluation information data to the server.

Input: Structured evaluation information data and reference to the associated job ID or proposal ID.

Processing: The terminal packages the evaluation information into a structured payload, associates it with the original session or job, and sends it via HTTPS to the server's feedback endpoint.

Output: Feedback payload received by the server.

### Step 23:

The server generates a revised prompt sentence based on the feedback.

Input: Original prompt sentence, evaluation information data from the user, and attribute information data or interior plan data.

Processing: The server interprets user feedback to identify which attributes should be adjusted (for example, color temperature, material, density of furniture). The server modifies specific segments of the original prompt sentence or appends additional constraints, such as “use warmer lighting,” “use natural wood materials,” or “add indoor plants.” The server combines these modifications with the existing room category, interior style category, feature amount data, and budget information to produce a revised prompt sentence.

Output: A revised prompt sentence tailored to the user's feedback.

### Step 24:

The server re-invokes the generative AI model with the revised prompt sentence.

Input: Revised prompt sentence and image data of the space.

Processing: The server constructs a new model request payload, sends it to the generative AI model service, and receives revised visual representation data. The server optionally re-runs object detection, attribute extraction, product matching, and combination optimization steps using the revised images and user constraints.

Output: Updated interior design images, updated candidate product sets, and updated interior plans reflecting user feedback.

### Step 25:

The server sends refined proposals to the terminal for further evaluation.

Input: Updated proposal information data including revised images and product lists.

Processing: The server serializes and transmits the updated data to the terminal via HTTPS.

Output: Refined proposal information available at the terminal, enabling the user to continue the evaluation-refinement cycle or to finalize product selections.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interior design support systems that utilize computer-implemented image generation still suffer from several technical limitations in how they process data and control interactions between a server, a generative AI model, and client devices. In many existing approaches, a generative model is simply treated as a black box that converts an input text description into an image. Such approaches typically do not structure the internal data flow so that downstream computational modules can reliably interpret generated images, correlate detected visual elements with structured product data, or enforce budget constraints in a consistent and reproducible manner. As a result, the overall system often behaves as a loosely coupled sequence of ad hoc services rather than as an integrated computing architecture optimized for interior design planning and product recommendation.

In particular, conventional systems do not provide a processor-controlled pipeline in which: (i) an image of a physical or virtual space is first analyzed to determine a space category; (ii) a prompt sentence for a generative AI model is programmatically constructed based on both this category and user-supplied design conditions; (iii) the generated visual representation is automatically parsed into machine-readable element information that includes positions and classifications of interior elements; and (iv) this element information is algorithmically linked, under budget constraints, to product information retrieved from storage and external services. Without such a pipeline, the system cannot consistently produce coherent mappings between abstract design concepts, generated images, and purchasable items, and cannot effectively leverage optimization techniques over product combinations.

Furthermore, existing systems typically lack technical mechanisms by which a processor generates association information that binds visual element coordinates and classifications in a generated image to corresponding product records and purchase links, and then generates control information such that a user terminal can render interactive visualizations where clicking or selecting an element within the image triggers access to related product data. This absence of a structured association layer results in fragmented user interfaces, increased latency due to redundant searches, and inefficient use of computing resources on both the server side and the client side.

Additionally, many prior systems do not incorporate a processor-executed optimization process that distributes a user's budget across detected elements and selects product combinations based on computed target price ranges. Instead, they often perform simple filtering or sorting at the product level, which fails to address the global constraint of staying within a total budget while preserving the visual and categorical coherence of the generated interior design. This leads to technically suboptimal data processing, where the server cannot compute globally constrained solutions and must rely on heuristic or manual adjustments.

Accordingly, there is a need for a computer-implemented system in which a processor orchestrates image acquisition, category determination, prompt sentence generation, generative AI invocation, image recognition, element information generation, budget-aware product search, and purchase link generation in a unified architecture. Such a system should improve the way data is represented, stored, associated, and optimized across these stages, thereby improving the functioning of the computer system itself in terms of structured data flow, efficient query execution, reduced redundancy, and interactive rendering of design and product information on user terminals.

The specific processing by the specific processing unit 290 of the data processing device 12 in Example 2 is realized by the following means.

The present invention provides a server comprising a processor configured to acquire an image of a space using an imaging apparatus, analyze the acquired image to extract a feature of the image and determine a category of the space, generate, based on the determined category and design conditions including a prompt sentence received from a user, a prompt sentence to be input to a generative AI model, instruct the generative AI model to generate a visual representation of an interior design, obtain the visual representation generated by the generative AI model, analyze the visual representation by using an image recognition algorithm to identify an element in the visual representation, generate element information including attribute information, position information, and classification information for each element, search, based on the element information and budget information received from the user, an information storage device and an external information providing service to acquire product information corresponding to the element, select the product information in consideration of the budget information by executing an optimization process that calculates a target price range for each element and selects a combination of the product information satisfying the target price range, generate association information that associates the position information and the classification information for each element with the selected product information, generate purchase connection information corresponding to the selected product information, and generate control information for causing a user terminal to display the visual representation together with an association between each element and the purchase connection information based on the association information. This enables an integrated and technically improved data processing pipeline in which the server systematically transforms raw image data and user-supplied design conditions into structured prompts, invokes a generative AI model, converts resulting visual data into element-centric representations, performs constrained optimization over product data, and generates machine-interpretable association and control information, thereby enhancing the efficiency, reliability, and interactivity of computer-implemented interior design planning and product recommendation.

The term “processor” refers to a hardware or virtual computing unit, such as a central processing unit or a processing core in a server, that executes instructions to perform the functions described in the present specification.

The term “imaging apparatus” refers to any hardware device configured to capture an image of a physical or virtual space, including but not limited to a digital camera, an image sensor, or an image-capturing module of a terminal.

The term “image of a space” refers to digital image data representing at least a part of an interior or exterior environment, acquired by the imaging apparatus and processable by the processor.

The term “category of the space” refers to a classification label or set of labels assigned to the space based on analysis of the image, such as a room type, usage type, or style type, which is used as a condition for subsequent processing.

The term “design conditions” refers to information used to specify requirements or preferences for an interior design, including at least a prompt sentence received from a user and optionally additional parameters such as style, function, or budget.

The term “prompt sentence” refers to a text string describing desired characteristics of an interior design or space, which is input to a generative AI model as a condition for generating a visual representation.

The term “generative AI model” refers to a machine-learned model, implemented in software and executed on computing hardware, that receives a prompt sentence or other input data and outputs generated data, such as an image representing an interior design.

The term “visual representation of an interior design” refers to digital image data generated by the generative AI model that depicts a layout, arrangement, or appearance of elements in an interior space.

The term “image recognition algorithm” refers to a software-implemented computational method, including but not limited to a machine learning model, configured to analyze image data and identify one or more elements, features, or regions within the image.

The term “element” refers to a visually discernible object or component depicted in the visual representation, such as a piece of furniture, a fixture, or a decorative item, which can be identified and processed individually.

The term “element information” refers to structured data associated with each element, including at least attribute information and optionally position information and classification information, which is generated by the processor.

The term “attribute information” refers to data describing one or more properties of an element, such as color, size, material, style, or functional category, derived from analysis of the visual representation or related data.

The term “position information” refers to data indicating a location or region of an element within the visual representation, such as coordinates, a bounding box, or a segmentation mask.

The term “classification information” refers to data indicating a category or class assigned to an element, such as a type of furniture or a type of fixture, which can be used to distinguish between different kinds of elements.

The term “budget information” refers to data received from a user indicating a monetary constraint or range, including at least a total budget value for an interior design and optionally additional constraints such as per-element limits.

The term “information storage device” refers to any hardware or software-based storage component, such as a database system, file system, or memory device, configured to store product information or related data for retrieval by the processor.

The term “external information providing service” refers to a remote computing service, such as an online catalog or a data-providing server, that can be accessed over a communication network to retrieve product information or related information.

The term “product information” refers to data describing a purchasable item corresponding to an element, including at least an identifier, a name, and a price, and optionally images, specifications, ratings, or availability.

The term “target price range” refers to a monetary range calculated for each element based on the budget information, indicating a desired lower and/or upper bound of price for a corresponding product.

The term “optimization process” refers to a computation executed by the processor that selects a combination of product information under one or more constraints, including at least the budget information and the target price range, in accordance with an objective function.

The term “association information” refers to data generated by the processor that associates position information and classification information of an element in the visual representation with corresponding product information, enabling linked processing and display.

The term “purchase connection information” refers to data enabling access to a purchase interface for a product, such as a network address, a resource locator, or an identifier usable to retrieve a purchase page from an external service.

The term “control information” refers to data generated by the processor for transmission to a user terminal, which instructs the user terminal how to display the visual representation, the elements, and the corresponding purchase connection information in an associated manner.

The term “user terminal” refers to any computing device operated by a user, such as a mobile device, a personal computer, or a tablet, that is configured to communicate with the server, display information, and accept user input.

In one embodiment, the system includes a server, one or more terminals, and at least one imaging apparatus. The server includes a processor, a memory, a non-transitory storage device, and a network interface. The terminal includes a processor, a memory, a display, an input interface, and a network interface. The imaging apparatus is, for example, a digital camera integrated in a mobile terminal, a stand-alone network camera, or an image sensor module connected to the terminal.

The server executes server-side software implemented on a computing platform such as a general-purpose server equipped with one or more central processing units and one or more graphics processing units. The server runs an operating system such as a server-class operating system and a web application framework such as a scripting-language-based framework or a compiled-language-based framework. The server further executes a machine learning runtime environment such as a tensor-based framework or a symbolic computation framework to run a generative AI model and an image recognition model.

The server stores, in the storage device, program modules including a prompt generation module, a generative image interface module, an image analysis module, a product retrieval module, an optimization module, and an association and control module. The server also stores a trained generative AI model, which in one example is an image generation model of a diffusion type, implemented in a tensor-based framework and trained on large-scale interior imagery and text annotations. The server further stores a trained image recognition model, such as a convolutional neural network or a vision transformer, configured to detect interior elements in images.

The terminal executes client-side software such as a web browser application or a native application. The terminal displays user interface screens, receives input from a user, and transmits prompt sentences, budget information, and other parameters to the server via a communication network. The terminal receives control information, image data, and purchase connection information from the server, and renders an interactive display in which the user can visually inspect a generated interior design and select associated product links.

The user operates the terminal to capture or select an image of a space using the imaging apparatus. The terminal acquires raw image data from the imaging apparatus, for example in a compressed image format, and transmits the image data to the server. The server receives the image data and stores the image in a storage system such as an object storage service. The server writes metadata, such as image resolution, capture time, and device information, to a relational or document-oriented database.

The server analyzes the acquired image to determine a category of the space. The server loads the image into memory and applies a trained classification model that takes as input a tensor representation of the image and outputs category scores for possible room types and style clusters. In one embodiment, the classification model is a convolutional neural network with multiple convolution layers, pooling layers, and fully connected layers, trained using supervised learning with a cross-entropy loss function on labeled interior images. The server computes feature maps from the image, aggregates them through global average pooling, and obtains a probability distribution over categories such as “living space type,” “sleeping space type,” or “eating space type.” The server selects the category having the highest probability as the category of the space and stores the selected category as structured data associated with the image.

The user further operates the terminal to input a prompt sentence that expresses design conditions. The terminal presents a text input field on the display and the user types a prompt sentence such as “Modern living room with a gray L-shaped sofa, a wooden coffee table, and warm ambient lighting, budget under 1500 dollars.” or “Scandinavian-style bedroom with light wood furniture and a budget under 1000 dollars.” or “Vintage-style dining room with a large wooden table, mismatched chairs, and an industrial pendant light, total budget under 2000 euros.” or “Minimalist Japanese living room with a low wooden table, neutral colors, and hidden storage solutions.” The terminal transmits the prompt sentence and the budget information, if present in the sentence or in a separate input, to the server.

The server receives the prompt sentence and budget information and generates a refined prompt sentence to be input to the generative AI model. The server uses a prompt generation module that parses the user's prompt sentence, associates it with the previously determined category of the space, and constructs an extended textual specification. In one embodiment, the server uses a rule-based system that maps the category of the space to canonical tokens and inserts style constraints, color constraints, and furniture requirements into the refined prompt sentence. For example, if the category of the space is determined as a living space type and the user's prompt sentence includes the phrase “modern living room,” the server augments the prompt with explicit tokens such as “high-resolution interior render, perspective view, consistent lighting, photo-realistic materials.” The server thus generates a structured prompt sentence that is optimized for the generative AI model, and stores the refined prompt as text data.

The server inputs the refined prompt sentence to the generative AI model. In one example, the generative AI model is a diffusion-based generative model comprising a text encoder and an image decoder. The server converts the refined prompt sentence into a sequence of tokens using a tokenizer, and the model encodes the tokens into an embedding vector. The server then runs a denoising process in latent space, where an initial noise tensor is iteratively refined through a sequence of neural network layers according to a scheduled variance-reduction procedure. The generative AI model uses learned parameters that were obtained by training on pairs of interior images and text descriptions using a loss function such as a mean-squared error between predicted noise and actual noise in the diffusion process. The server executes forward passes of the model on a graphics processing unit to accelerate the matrix multiplications and convolution operations. As a result, the model outputs a generated image representing an interior design consistent with the refined prompt sentence.

The server receives the generated image as a tensor or an encoded image file and stores it in the storage device. The server then analyzes the generated image to identify interior elements. The server feeds the generated image into the image recognition model, which may be an object detection network such as a region-based convolutional neural network or a transformer-based detector. The image recognition model outputs bounding boxes, class labels, and confidence scores for each detected element. For instance, the model may detect elements corresponding to a sofa, a table, a lighting fixture, a storage unit, and a floor covering.

The server converts the detection output into element information. The server creates a data structure such as a list of records, where each record includes position information (for example, coordinates of a bounding box), classification information (for example, category labels such as “seating furniture,” “horizontal surface,” “illumination device”), and attribute information. The attribute information may be derived from color histograms, texture descriptors, and aspect ratios computed from the pixels within each bounding box. The server may also apply a separate attribute classification model that infers style tags such as “modern,” “Scandinavian,” or “minimalist,” and material tags such as “wood,” “metal,” or “textile,” using a classifier trained on interior imagery. The server thus stores element information in a structured format, such as a document-oriented record, and associates it with the generated image and the original prompt.

The server receives budget information from the terminal and computes a target price range for each element. The server applies an algorithm that allocates a total budget among detected elements based on heuristic weights or learned distributions, such as assigning a larger portion of the budget to seating furniture and a smaller portion to decorative items. The server uses numerical computation libraries to compute target price intervals, ensuring that the sum of the upper bounds does not exceed the given budget while allowing flexibility in individual item selection.

The server retrieves product information corresponding to each element. The server communicates with an information storage device such as a relational database or a search index storing product records. The server constructs search queries containing classification information (for example, “seating furniture”), attribute information (for example, “gray fabric,” “L-shaped”), style tags (for example, “modern”), and the target price range. The server then transmits these queries to the database engine or to an external information providing service accessible over the network. The external service returns candidate products with identifiers, names, prices, and metadata. The server filters the candidate products by verifying that their prices fall within the target price range and that their attributes match the element information above a threshold similarity measure.

The server executes an optimization process to select a combination of products that satisfies global constraints. In one embodiment, the server formulates an objective function that maximizes an overall compatibility score between the selected products and the element information while satisfying the budget constraint. The server may implement a linear or integer programming solver, or a greedy approximation algorithm, to select one product per element such that the total cost does not exceed the budget and the compatibility score is near optimal. The server thus obtains a consistent set of product information linked to the generated image.

The server generates association information linking elements and product information. The association information includes, for each element, the position information and classification information of the element in the generated image and the identifier of the selected product. The server stores this association information as structured data and uses it to generate control information for the terminal. The control information includes rendering instructions such as “draw highlight rectangle at given coordinates when the user hovers over a product item” and mapping instructions such as “when the user selects this region of the image, open the corresponding purchase connection information.”

The server generates purchase connection information for each selected product. The server constructs a network resource locator or other access identifier for a purchase interface provided by an external service. The server may append tracking parameters or session identifiers required by the external service. The server then packages the purchase connection information together with the generated image data and the control information and transmits this data to the terminal over a communication network.

The terminal receives the generated image, the association information, the control information, and the purchase connection information from the server. The terminal decodes the image and stores it in memory. The terminal interprets the control information to build a graphical user interface in which the generated interior design is displayed and interactive regions corresponding to elements are overlaid. The terminal may draw clickable or tappable hotspots on top of the image according to the position information, and may display item lists or tooltips by referencing the classification information and associated product names.

The user views the generated interior design image on the terminal and interacts with the elements. When the user selects an element, the terminal uses the association information to retrieve the corresponding purchase connection information and initiates a network request to the external service. The external service returns a purchase page, which the terminal displays within a browser or an embedded web view.

The described arrangement provides technical improvements beyond simple automation of human tasks. The server uses specific data structures for element information and association information, and uses trained machine learning models with defined architectures to transform raw image data and text into structured, actionable data. The server reduces communication overhead by aggregating multiple product search requests into single batched queries and by caching intermediate results such as category determinations and attribute inferences. The server improves computational efficiency by offloading high-dimensional tensor computations to the graphics processing unit and by using optimized numerical routines for the optimization process.

The system improves accuracy and consistency in interior design planning relative to manual or ad hoc processes. The server systematically uses the determined category of the space to constrain the refined prompt sentence, thereby reducing irrelevant image generation and improving the match between the generated image and the physical space. The server uses learned models for element detection and attribute inference, which are trained with explicit loss functions and weight updates on large datasets, thereby reducing misclassification errors compared to heuristic image analysis. The server's optimization process enforces budget constraints at the system level, enabling selection of product combinations that collectively satisfy constraints, which cannot be reliably achieved by simple product-by-product filtering. The server and terminal cooperate to reduce user interaction latency and cognitive load. The terminal does not merely display static images but uses control information from the server to render interactive overlays and linked product information. This architecture allows the server to perform heavy computation centrally while the terminal performs lightweight rendering, thus balancing processing load and improving responsiveness.

In alternative embodiments, the server may use different generative architectures, such as a generative adversarial network with a generator and discriminator, or a transformer-based autoregressive image generator. The server may also use different image recognition backends, such as a fully convolutional segmentation network for pixel-wise labeling of elements. The data structure for element information may be implemented as a graph, where nodes represent elements and edges represent spatial or conceptual relationships. The optimization process may be replaced by a reinforcement learning-based selection mechanism that learns to propose product combinations that maximize user satisfaction metrics.

In another embodiment, the terminal may locally execute a lightweight classification or caching module that pre-categorizes user-entered prompt sentences and sends category hints to the server, further reducing processing on the server side. In still another embodiment, the imaging apparatus may be a three-dimensional depth camera and the server may construct three-dimensional representations of the space and use them to refine placement and selection of products.

By organizing the data flow into specific structured representations, by using defined machine learning architectures with explicit training regimes, and by integrating optimization and association layers that are not present in conventional systems, the server achieves improved processing speed, improved accuracy in element-product mapping, reduced redundant network communication, and enhanced user interaction capabilities. The described embodiments thus provide a concrete implementation that improves computer technology itself in the context of interior design generation and product recommendation.

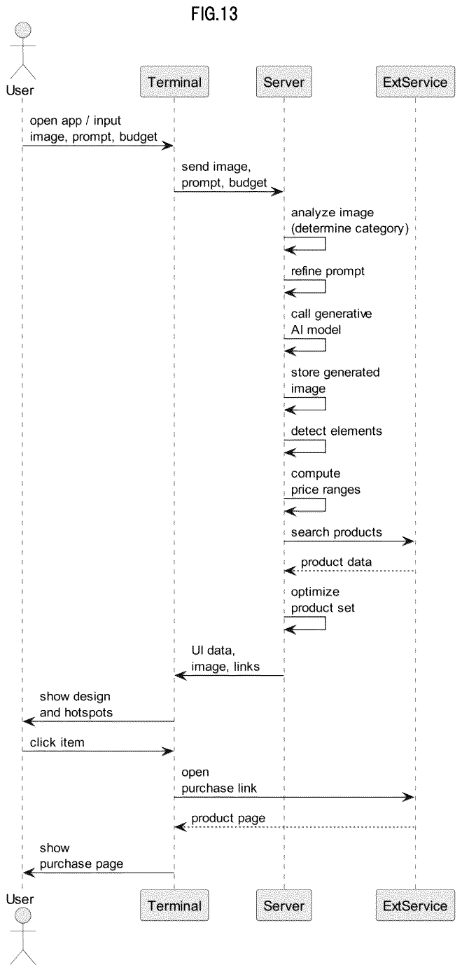

The following describes the processing flow using FIG. 13.

### Step 1:

The user operates the terminal to acquire or select an image of a space.

The terminal receives, as input, raw image data from an imaging apparatus integrated in or connected to the terminal.

The terminal encodes the image in a digital format, attaches metadata such as capture time and device identifier, and outputs a transmission packet containing the image data and metadata to the server over a network.

### Step 2:

The server receives the transmission packet from the terminal.

The server takes, as input, the encoded image data and associated metadata.

The server decodes the image data, stores the image in a storage device, registers an image record in a database with a unique image ID, and outputs a stored image reference for subsequent processing.

### Step 3:

The server analyzes the stored image to determine a category of the space.

The server receives, as input, the image reference and loads the corresponding image pixels into memory.

The server applies a trained classification model, for example a convolutional neural network, to compute feature maps from the image, aggregates the feature maps into a feature vector, calculates category scores for multiple space types, and outputs a selected category label together with a confidence value.

### Step 4:

The user operates the terminal to input a prompt sentence and budget information.

The terminal takes, as input, text characters typed by the user into a text input field and, optionally, numeric values entered into a budget field.

The terminal validates that the prompt sentence is not empty, parses the budget string into a numeric value, packages the prompt sentence and budget information into a request object, and outputs the request object to the server via a communication interface.

### Step 5:

The server receives the request object containing the prompt sentence and budget information.

The server uses, as input, the user-supplied prompt sentence, the budget information, and the previously determined category label.

The server normalizes the prompt sentence, performs tokenization to obtain a sequence of words or subwords, applies rule-based mappings to insert category-specific tokens, appends explicit design constraints such as style and lighting descriptors, and outputs a refined prompt sentence that is optimized for the generative AI model.

### Step 6:

The server inputs the refined prompt sentence to the generative AI model.

The server receives, as input, the refined prompt sentence and configuration parameters such as image resolution, sampling steps, and random seed.

The server encodes the refined prompt sentence using a text encoder, obtains an embedding vector, runs a generative algorithm such as a diffusion process or a generative adversarial process on a graphics processing unit to iteratively transform noise into a latent image representation, decodes the latent representation into pixel values, and outputs a generated interior design image as digital image data.

### Step 7:

The server stores and registers the generated interior design image.

The server uses, as input, the generated image data produced by the generative AI model.

The server compresses the image, uploads it to an object storage service, obtains a storage URL, creates a database record linking the generated image to the refined prompt sentence, category label, and user ID, and outputs a generated image reference including the storage URL and record identifier.

### Step 8:

The server analyzes the generated interior design image to detect interior elements.

The server receives, as input, the generated image reference and loads the image pixels into memory.

The server applies an image recognition model, such as an object detection network or a segmentation network, to compute feature maps, generate bounding boxes or segmentation masks, assign class labels and confidence scores to each detected element, and outputs a raw detection result comprising positions, classes, and scores for the elements.

### Step 9:

The server converts the raw detection result into structured element information.

The server uses, as input, the bounding boxes or masks, class labels, confidence scores, and the pixel values within each detected region.

The server calculates attribute features such as dominant color histograms, aspect ratios, and texture descriptors, optionally applies an attribute classifier to infer style and material tags, constructs, for each element, a record including position information, classification information, attribute information, and a detection confidence, and outputs an element information list associated with the generated image.

### Step 10:

The server computes target price ranges for the detected elements based on the user's budget.

The server receives, as input, the element information list and the budget information from the user.

The server assigns weight coefficients to element categories, computes a proportional allocation of the total budget to each element, adjusts allocations using numerical routines to ensure that the sum of target prices does not exceed the total budget, and outputs, for each element, a target price range that includes at least a lower bound and an upper bound.

### Step 11:

The server retrieves candidate product information from internal and external data sources.

The server takes, as input, the element information list and the target price ranges.

The server constructs search queries that combine classification information, attribute information, and target price constraints, submits the queries to an information storage device such as a product database and to external information providing services via application programming interfaces, receives product records including identifiers, names, prices, attributes, and images, filters the records to retain those matching the target price ranges and attribute similarity thresholds, and outputs candidate product sets for each element.

### Step 12:

The server executes an optimization process to select a combination of products.

The server uses, as input, the candidate product sets and the budget information.

The server defines an objective function that evaluates compatibility between selected products and element attributes and enforces the total budget constraint, applies an optimization algorithm such as integer linear programming or a greedy approximation to select at least one product per element while minimizing budget overflow and maximizing compatibility scores, and outputs a selected product list that specifies, for each element, one or more chosen product records.

### Step 13:

The server generates association information linking elements and selected products.

The server takes, as input, the element information list and the selected product list.

The server creates, for each element, a mapping record that associates the position information and classification information with the identifier of the selected product, stores these mapping records as association information, and outputs the association information structure that can be referenced during rendering and interaction.

### Step 14:

The server generates purchase connection information and control information for the terminal.

The server receives, as input, the selected product list and the association information.

The server constructs purchase connection information such as network resource locators for purchase pages, bundles the generated image reference, element information, association information, and purchase connection information into a response object, embeds display instructions and interaction rules as control information specifying how the terminal should associate image regions with product links, and outputs the response object to the terminal over the network.

### Step 15:

The terminal receives and interprets the response object from the server.

The terminal uses, as input, the response object including the generated image reference, element information, association information, purchase connection information, and control information.

The terminal downloads the generated image from the storage URL, decodes the image for display, parses the control information to construct an internal representation of interactive regions and corresponding product links, and outputs a prepared user interface state ready for rendering.

### Step 16:

The terminal renders the generated interior design and interactive elements on the display.

The terminal receives, as input, the decoded image and the user interface state.

The terminal draws the generated image in a main viewing area, overlays graphical indicators such as bounding boxes or icons at positions specified by the position information, associates each overlay with corresponding purchase connection information based on the association information, and outputs a visual display in which the user can select elements and view related product information.

### Step 17:

The user interacts with the rendered interior design to access product information.

The terminal detects, as input, a user interaction event such as a tap or click on an overlayed region of the generated image.

The terminal identifies the corresponding element by comparing the event coordinates with the position information, retrieves the associated purchase connection information from its internal state, initiates a network request to the external information providing service using the purchase connection information, and outputs a new display that shows a product detail page or purchasing interface obtained from the external service.

### Step 18:

The server optionally logs interaction data and updates system parameters.

The server receives, as input, analytics data from the terminal indicating which elements and products the user selected.

The server stores the interaction data in a log database, aggregates the data to update statistics such as selection frequencies and conversion rates, optionally adjusts weighting factors in the optimization process or rule-based prompt refinement module based on observed user behavior, and outputs updated configuration parameters for future processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interior planning support systems typically operate as static catalog browsers or simple rule-based recommendation engines. In such systems, a processor merely displays pre-authored layouts or filters a product database based on a few user-specified conditions. The processor does not deeply analyze an image of a user's actual space, does not dynamically construct machine-readable and human-readable specifications for that space, and does not utilize a generative AI model via a context-rich prompt sentence to synthesize new interior planning information. As a result, the system cannot automatically adapt layouts and product selections to the specific geometry, visual style, budget constraints, and emotional state of the user in a coherent, computationally efficient manner.

In addition, existing systems tend to treat image processing, product retrieval, and user interface rendering as separate pipelines with limited interaction. The processor typically does not maintain a unified representation that ties together (i) low-level features extracted from the space image, (ii) higher-level semantic category information, (iii) structured constraint information including funding information and user state information, (iv) the input and output context of a generative AI model, and (v) the mapping between generated visual information and concrete product data. This separation leads to redundant computations, ad hoc integrations, and error-prone manual steps when trying to produce interactive visual proposals that are directly linked to purchasable articles.

Furthermore, conventional systems do not exploit prompt sentence construction as a first-class computational mechanism. They do not systematically generate prompt sentences encoding detected objects, space categories, candidate article sets, and constraint information in a structured way, nor do they leverage the output of a generative AI model as an intermediate, machine-parseable interior planning specification. Consequently, the processor has limited ability to refine proposals in an iterative, programmatic loop (for example, when the funding condition is violated or when user feedback indicates dissatisfaction), and cannot efficiently reuse generative outputs to drive automatic scene generation and product linking. There is therefore a need for an improved computer-implemented system in which a processor performs integrated acquisition and analysis of space images, generation of constraint-aware prompt sentences, interaction with a generative AI model to obtain interior planning information, and automatic construction of visual information and product links, all within a unified data flow. Such a system should improve the functioning of the computer by reducing manual design steps, enabling dynamic adaptation to user-specific constraints and states, and establishing a consistent mapping between abstract planning information and concrete, interactively selectable visual elements.

The specific processing by the specific processing unit 290 of the data processing device 12 in Application Example 2 is realized by the following means.

The present invention provides a server comprising a processor configured to acquire an image of a space by using an imaging device; analyze the acquired image by applying an image processing algorithm to extract feature information including object information and style information, and determine category information of the space based on the feature information; use the category information and constraint information including the object information, funding information acquired from a user, and state information of the user to search a storage device that stores candidate article information, and extract candidate article information that satisfies the constraint information; generate a prompt sentence expressed in a natural language based on the category information and the candidate article information, and cause a generative information processing model to receive the prompt sentence as input and to output response information including interior planning information; extract selected article information and arrangement information from the response information, and generate scene information for visual representation that defines an arrangement of the selected article information in the space; input the scene information to an image generation algorithm or a three-dimensional rendering algorithm to generate visual information corresponding to the interior planning information, and store the visual information in association with the selected article information; and use association information that associates predetermined regions in the visual information with the selected article information to cause a user terminal to display the visual information, and in response to an operation input on the predetermined regions by the user, present the selected article information. This enables an integrated computer-implemented pipeline in which the server automatically transforms raw image data and user constraints into constraint-compliant interior planning information, renders that information as interactive visual content, and directly links visual elements to purchasable articles, thereby improving the technical functioning of the computer system in generating, updating, and serving personalized interior design proposals.

The term “space” refers to a physical environment such as a room, area, or region whose interior is to be analyzed, categorized, and planned.

The term “imaging device” refers to any device configured to capture visual information of a space, including but not limited to a camera, a sensor-equipped mobile terminal, or an image-capturing apparatus.

The term “image processing algorithm” refers to a computational procedure executed by the processor to process image data, including operations such as resizing, filtering, feature extraction, object detection, and style analysis.

The term “feature information” refers to data representing characteristics extracted from an image of the space, including at least object information and style information.

The term “object information” refers to feature information indicating the presence, type, or attribute of a physical item within the space, such as furniture, fixtures, or decorative elements.

The term “style information” refers to feature information indicating a visual or design style of the space, such as color tendencies, material preferences, or layout characteristics.

The term “category information” refers to classification information that characterizes the space according to a predefined category set, such as an interior style, usage type, or other semantic grouping.

The term “constraint information” refers to structured information used to restrict or guide interior planning, including at least object information, funding information, and state information of the user.

The term “candidate article information” refers to data items in a storage device that describe potential objects or goods that can be placed in or associated with the space, including identifiers, attributes, and price information.

The term “selected article information” refers to a subset of candidate article information chosen for inclusion in an interior design plan, as determined based on response information from the generative information processing model and constraint information.

The term “funding information” refers to information representing a financial condition associated with the user, including a budget or spending limit applicable to selection of articles.

The term “state information of the user” refers to information representing a condition or context of the user, which may include emotional state, preference state, or other status data relevant to interior planning.

The term “storage device” refers to any memory or data storage component configured to store candidate article information, images, association information, or other data, including local or remote storage.

The term “prompt sentence” refers to a sequence of characters expressed in a natural language and constructed to specify conditions or instructions to a generative information processing model.

The term “generative information processing model” refers to a computational model configured to generate output information, such as text or structured data, in response to an input prompt sentence, based on learned parameters.

The term “response information” refers to information output by the generative information processing model in response to the prompt sentence, including interior planning information and any associated descriptive content.

The term “interior planning information” refers to information describing an interior design plan for the space, including selected article information, arrangement information, and optional explanatory or stylistic information.

The term “arrangement information” refers to information that indicates relative or absolute positioning, orientation, or layout of selected articles within the space.

The term “scene information for visual representation” refers to data defining a scene configuration, including arrangement information, visual attributes, and optional camera parameters, used to generate visual information corresponding to an interior plan.

The term “image generation algorithm” refers to a computational procedure configured to generate two-dimensional visual information, such as an image or rendering, based on scene information or descriptive data.

The term “three-dimensional rendering algorithm” refers to a computational procedure configured to generate visual information by rendering a three-dimensional scene, including geometry, materials, and lighting, into a two-dimensional or three-dimensional output.

The term “visual information” refers to data representing a visual depiction of the space and selected articles, including at least one image or rendering that corresponds to interior planning information.

The term “association information” refers to data that links predetermined regions in the visual information to corresponding selected article information, enabling interaction with visual elements.

The term “predetermined region” refers to a portion or area of the visual information, such as a pixel region or bounding area, designated as corresponding to a specific article.

The term “product information” refers to data associated with an article that is available for acquisition, including at least an identifier, price, descriptive attributes, and purchase connection information.

The term “purchase connection information” refers to information used to establish access to a network-based provision platform for acquiring a corresponding article, such as a uniform resource locator, endpoint, or transaction link.

The term “network-based provision platform” refers to a service or system accessible via a communication network and configured to provide information about or enable acquisition of articles.

The term “user terminal” refers to any electronic apparatus operated by a user and configured to communicate with the server, display visual information, and accept user input, including but not limited to a mobile terminal, tablet, or personal computer.

In one embodiment, a server executes a computer program on one or more processors and cooperates with at least one terminal operated by a user. The server and the terminal are connected through a communication network such as the Internet. The server comprises a central processing unit, a main memory, a nonvolatile storage device, and a network interface. The terminal comprises an imaging device such as a digital camera module, a display device, an input device, a microphone, and a communication interface.

The server stores executable software components including an image-processing module, a feature-extraction module, a categorization module, a constraint-management module, a prompt-generation module, a generative AI interface module, a response-parsing module, a scene-construction module, an image-generation module, an association-management module, and a product-linking module. The server also stores trained machine-learning models, such as a convolutional neural network for object detection, a style-classification network, and a generative AI model such as a transformer-based language model. The terminal runs a client application configured to control the imaging device, present graphical user interfaces, and exchange structured messages with the server.

The server uses conventional image-processing libraries, such as a general-purpose image library corresponding to OpenCV, to perform preprocessing operations including resizing, color normalization, and noise reduction on an input image. The server uses a deep neural network framework, such as a generic implementation corresponding to TensorFlow or PyTorch, to execute a convolutional neural network trained for object detection and style classification. In one example, the convolutional neural network has multiple convolutional layers with rectified linear unit activation functions, max-pooling layers, and fully connected layers, and outputs a set of object bounding boxes, object class probabilities, and a style vector representing color scheme and layout features of the space.

The server defines an internal data structure for feature information as a record that includes at least: a list of detected objects with object class identifiers, bounding box coordinates, and confidence scores; a style feature vector; and metadata about the input image. The server converts this feature information into category information by applying a categorization algorithm. In one embodiment, the server applies a softmax classifier on the style feature vector to assign labels such as “modern,” “natural,” “minimal,” or “classic,” and stores the category information in a relational database management system such as a generic SQL database.

The server uses a constraint-management module to create constraint information. The constraint information includes at least the object information extracted from the image, funding information provided by the user, and state information of the user. The server stores the funding information and the state information as structured fields associated with a session identifier. The funding information includes a budget amount and optional limits per item type. The state information includes preference flags, emotional-state labels, and optional usage-purpose labels.

The terminal acquires the funding information by displaying an input form on the display device and receiving a numerical value representing the budget and additional preference selections from the user. The terminal transmits the funding information to the server in a structured format. The terminal optionally acquires state information of the user by using the imaging device and the microphone to capture facial expressions and speech. The terminal transmits images of the user and audio data to the server. The server uses an emotion-recognition network, implemented for example as a convolutional neural network for facial images and a recurrent or transformer-based network for audio features, to classify the emotional state of the user. The server trains the emotion-recognition network in advance using supervised learning with a cross-entropy loss function and labeled emotion datasets, and updates the model parameters by gradient descent. The server uses the predicted emotional state and a confidence score as part of the state information.

The server uses the category information and the constraint information to search a storage device containing candidate article information. The server stores the candidate article information in database tables that include article identifiers, article types, style tags, size parameters, color attributes, and price values. The server performs SQL queries that join style tags with category labels and filter by price using the funding information. The server may use an index structure, such as a B-tree index on price and style tag columns, to improve query performance. The server thereby extracts a set of candidate articles that satisfy the constraint information.

The server constructs an internal representation of candidate article information as a list of records, each record containing at least an article identifier, a type, a color descriptor, a price, and one or more style tags. The server passes this candidate article information to the prompt-generation module. The prompt-generation module constructs a prompt sentence in a natural language by combining template strings and variable fields. For example, the server can generate a prompt sentence such as:
“You are an interior designer. The room is classified as a modern living room. Detected objects: a gray fabric sofa, a small wooden coffee table, and a floor lamp. The user's emotion is tired and seeking relaxation. The total budget is 50,000. The following is a list of candidate items (name, type, color, price, style tags). Using only items from the candidate list, propose one or two complete interior coordinations that fit the budget and emphasize a relaxing atmosphere. For each proposal, output: (1) a list of selected items with quantities, (2) a short explanation, and (3) a textual description of the layout.”

The server transmits this prompt sentence to a generative AI model through the generative AI interface module. In one embodiment, the generative AI model is implemented as a transformer-based neural network with multiple self-attention layers, feed-forward layers, and layer normalization, pre-trained on large text corpora and optionally fine-tuned on interior design dialogues or descriptions. The server configures the generative AI model with a vocabulary, tokenization rules, positional encodings, and a set of parameters such as temperature and maximum sequence length.

The server trains or fine-tunes the generative AI model in advance using supervised learning or instruction-tuning methods. The server defines a loss function, such as a token-level cross-entropy loss, to minimize the difference between predicted tokens and reference tokens in training sequences. The server uses an optimizer such as stochastic gradient descent with momentum or an adaptive optimizer to update network weights, and may employ data augmentation methods such as paraphrasing of training prompts and synthetic generation of interior descriptions to improve robustness.

The server receives the response information output from the generative AI model. The response information includes interior planning information in natural-language form. The server uses the response-parsing module to extract selected article information and arrangement information from the response. In one embodiment, the server constrains the model output by adding instructions in the prompt sentence to return data in a structured pattern, such as numbered lists or key-value pairs, and uses a deterministic parsing routine to detect article identifiers and layout instructions. The server converts the extracted information into a machine-readable representation, for example, a structured record listing selected articles and their placement rules (such as “place sofa against right wall,” “place rug in front of sofa”).

The server generates scene information for visual representation based on the arrangement information and the selected article information. The server defines a scene graph data structure including nodes for the space, wall planes, floor plane, and article instances. Each article node contains a reference to a geometric model or a symbolic representation, transformation parameters such as position and rotation, and material parameters such as color and texture identifiers. The server computes approximate room dimensions from the input image by using geometric cues or metadata and maps the arrangement information to specific coordinates in the scene coordinate system.

The server inputs the scene information to an image-generation algorithm or a three-dimensional rendering algorithm. In one variation, the server uses a 3D rendering pipeline corresponding to a generic 3D graphics engine, which loads the scene graph, rasterizes geometry, computes lighting, and outputs a rendered image. In another variation, the server uses an image generative model corresponding to a diffusion-based or generative-adversarial model. In that case, the server converts the scene information into a descriptive prompt sentence such as:
“Generate a realistic image of a modern living room with a gray fabric sofa against the right wall, a small wooden coffee table in front of it, a warm floor lamp behind the sofa, and a beige rug in the center. Use soft warm evening lighting and a calm atmosphere.”

The server supplies this prompt sentence, and optionally the original room image as a conditioning input, to the generative image model. The generative image model uses a neural network with encoder-decoder architecture and attention mechanisms to iteratively refine a latent image representation and produce the final image.

The server stores the generated visual information, including image files and metadata, in the storage device in association with the selected article information and the scene information. The server computes association information between predetermined regions in the visual information and individual selected articles. When the server uses 3D rendering, the server can record screen-space bounding boxes for each rendered article by querying the graphics engine for object ID buffers. When the server uses a generative image model without direct object mapping, the server can apply an object-detection network to the resulting image and match detected regions to previously selected articles using similarity metrics on color, shape, and type. The server stores the association information as a mapping between region identifiers and article identifiers.

The terminal requests the visual information and the association information from the server. The terminal downloads the image data and displays it on the display device. The terminal overlays interactive elements, such as icons or bounding outlines, over the predetermined regions corresponding to selected articles. The terminal receives user input via touch or pointer events and identifies the region selected by the user. The terminal requests detailed selected article information from the server and presents it to the user in a detail view that includes name, attributes, and a purchase connection identifier.

The server retrieves product information corresponding to the selected article information by querying a product database and, optionally, by communicating with external commerce platforms through web-based interfaces. The server obtains the purchase connection information, such as a network resource identifier pointing to a transaction endpoint, and transmits this information to the terminal. The terminal opens the purchase connection information via a browser component or integrated view and thereby provides access to a network-based provision platform from which the article can be acquired.

The described configuration and data flow improve computer technology rather than merely automating human decision making. The server reduces redundant computations by maintaining a unified internal representation linking feature information, category information, constraint information, prompt sentences, generative responses, scene information, visual information, and association information. By structuring the data in this way, the server avoids repeated manual re-entry of constraints and reduces round-trip latency between modules. The use of structured prompt sentences that encode candidate article information, funding information, and user state information enables the generative AI model to output interior planning information that can be automatically parsed and reused as machine-readable input for subsequent modules. This improves processing efficiency and reduces parsing errors compared with unstructured natural-language exchanges.

The use of trained neural network models for object detection and style classification increases the precision of category determination compared with simple rule-based methods. The server uses learned feature representations in convolutional layers to capture texture and shapes, which allows robust performance on images with varying lighting and occlusions. The server improves computational efficiency by performing feature extraction once per input image and reusing the results across multiple planning iterations, instead of recomputing detections for each proposal.

The joint use of scene information and 3D or generative image rendering, combined with association information, enables the server to produce interactive visual outputs that directly correspond to specific data records in the candidate article database. This tight coupling reduces the number of network requests required to identify products, because the server can answer article inquiries based on precomputed mappings rather than repeated image analysis queries. As a result, the system can reduce communication load and response time when the user interacts with visual content.

The server uses iterative control of the generative AI model through prompt sentences that explicitly encode funding information and state information of the user. When the server detects that the generated plan violates the funding condition, the server adjusts the prompt sentence to tighten budget constraints and regenerates a plan. This non-conventional loop, which combines deterministic filtering of candidate articles and stochastic generative sampling under explicit constraints, produces interior plans that respect both financial and stylistic requirements with fewer iterations than traditional heuristic search or manual trial-and-error. Consequently, the server improves both the convergence speed and the quality of computational planning.

The server further improves computer functionality by employing specific training methods for the generative AI model. The server can fine-tune the generative model on a dataset of interior design prompts and structured plans, using controlled formats that match the system's prompt sentences and desired response structure. By constraining the model to output machine-parseable formats, the server reduces ambiguities and improves reliability in downstream parsing. During fine-tuning, the server can apply curriculum learning, gradually increasing prompt complexity, and can employ regularization techniques to avoid overfitting. These training strategies enhance the model's capacity to respond correctly to the structured prompt sentences used at runtime.

The described system is not limited to interior design applications. The same architecture can be applied to other planning tasks where an image of a space or object is analyzed, constraint information is applied, a generative AI model is controlled via prompt sentences, and visual information and product links are generated. For example, the server can be configured to plan arrangements of industrial equipment in a factory floor, or to plan layout of components in a laboratory bench. In these variations, the server adapts the object classes, category labels, and article databases to the relevant domain, but preserves the technical structure of feature extraction, constraint management, structured prompting, generative planning, scene construction, and interactive visualization.

In another embodiment, the server uses a different generative AI architecture, such as a sequence-to-sequence encoder-decoder model, instead of a transformer-based language model. The server encodes the prompt sentence into latent representations, and the decoder outputs interior planning information. In yet another embodiment, the server integrates a multimodal generative model that directly consumes both text and the original room image as input, thereby modifying the interior plan while visually preserving the structure of the input space. These alternative architectures still use the same technical approach: the server explicitly composes constraint-aware prompt sentences and uses the generative AI model as a computational module within a larger pipeline of image analysis, database search, scene construction, and visual rendering.

In all these embodiments, the server, the terminal, and the user cooperate through defined data structures and hardware-mediated operations, and the system as a whole achieves technical advantages such as improved processing speed, increased planning accuracy, reduced communication overhead, and reduced manual intervention in configuring interior visualizations.

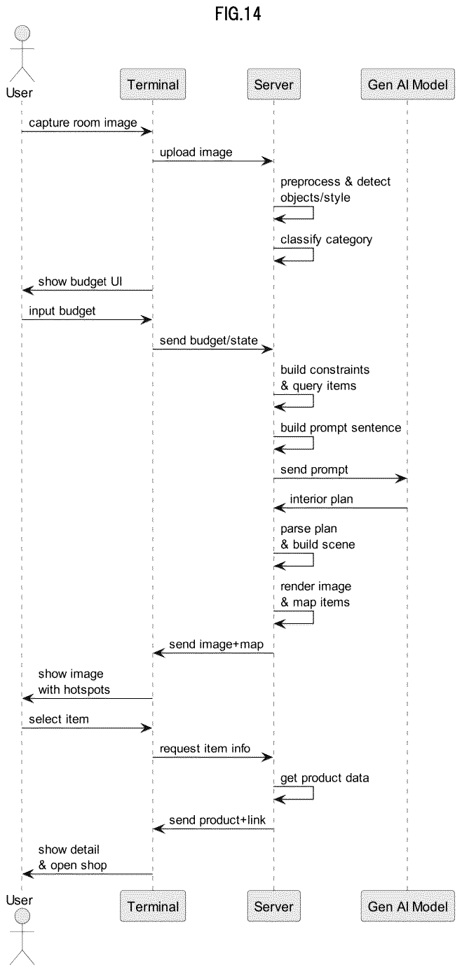

The following describes the processing flow using FIG. 14.

### Step 1:

User uses the terminal to capture a space image.

User operates the imaging device of the terminal (for example, presses a shutter button in an application) to capture one or more images of a room.

Input: physical scene of the room, terminal camera settings.

Output: digital image data (for example, JPEG or PNG) stored in the terminal.

Terminal converts raw sensor data into compressed image data, attaches metadata such as timestamp and device ID, and stores the image in local storage.

### Step 2:

Terminal sends the captured image to the server.

Terminal reads the stored image file, encapsulates the image data and metadata into a request message, and transmits it via a network protocol (for example, HTTPS) to a predefined server endpoint.

Input: local image file and associated metadata.

Output: network request containing image data received by the server.

Terminal may perform optional preprocessing such as resizing or compression to reduce file size before transmission.

### Step 3:

Server receives and stores the image data.

Server accepts the network request, validates the file format and size, and writes the image data into a storage device with a unique image identifier and a session identifier.

Input: incoming image data and metadata from the terminal.

Output: persistent image record containing an image ID, storage path, and session ID.

Server performs data processing to register the image entry in a database table and to associate it with the corresponding user account.

### Step 4:

Server preprocesses the image for feature extraction.

Server loads the stored image into memory and applies an image processing algorithm, such as resizing, color normalization, and noise filtering, using an image-processing library.

Input: stored raw image data for a session.

Output: preprocessed image tensor suitable for neural network input.

Server converts the image into a fixed-size numerical array and normalizes pixel values so that subsequent neural network computation is stable and efficient.

### Step 5:

Server performs object detection and style feature extraction.

Server feeds the preprocessed image into a convolutional neural network configured for object detection and style classification.

Input: preprocessed image tensor.

Output: feature information including a list of detected objects with bounding boxes and class probabilities, and a style feature vector.

Server performs data computation using convolution, pooling, and fully connected layers to compute high-dimensional feature maps, then applies detection heads and style classification heads to produce structured feature information.

### Step 6:

Server determines category information of the space.

Server applies a classification algorithm to the style feature vector and possibly to aggregated object information, and selects one or more category labels such as “modern,” “natural,” or “classic.”

Input: style feature vector and object detection results.

Output: category information representing the interior style or usage of the space.

Server performs data processing using a softmax layer or a trained classifier to map feature vectors to category probabilities and chooses the highest-scoring category.

### Step 7:

Terminal acquires funding information and user state information.

User enters a budget and preferences through a graphical user interface on the terminal, and optionally allows face and voice capture.

Input: user keystrokes, touch inputs, facial images, and audio signals.

Output: structured funding information (for example, total budget, item constraints) and raw user-state data (face images and audio clips) stored on the terminal.

Terminal packages these data items into structured fields and prepares them for transmission.

### Step 8:

Terminal sends funding and user-state data to the server.

Terminal transmits the budget values, preference settings, and optional user images and audio samples to the server via an API call.

Input: locally stored funding information and user-state data.

Output: network request containing constraint-related data received by the server.

Terminal may encode numeric values and strings in a structured format and encode multimedia data in a binary format for reliable transport.

### Step 9:

Server creates constraint information including funding and user state.

Server parses the received data, validates the budget range, and stores the funding information and user-state data in a constraint record associated with the session.

Input: funding information, facial images, audio data, and session ID.

Output: constraint information object including funding fields and placeholder state fields.

Server performs data processing to normalize currency units, clamp unreasonable values if needed, and mark the session as constraint-ready.

### Step 10:

Server infers user state information, including emotional state.

Server processes facial images with a facial emotion classifier and audio data with a speech-based emotion classifier, then aggregates the results.

Input: facial image data and audio feature data.

Output: state information of the user, including at least one emotion label and a confidence score.

Server performs data computation by passing the inputs through trained neural networks, computing feature vectors, and applying softmax layers to obtain emotion probabilities; the server then selects a dominant emotion and stores it within the constraint information.

### Step 11:

Server retrieves candidate article information from storage.

Server uses the category information and constraint information to build and execute queries on a product database containing article entries.

Input: category information, funding information, and style-related state information.

Output: a filtered list of candidate articles, each with attributes such as type, color, style tags, size, and price.

Server performs data processing by executing database queries with conditions on style tags and price ranges, aggregating results across tables, and ranking them by relevance and compatibility.

### Step 12:

Server constructs a detailed prompt sentence for the generative AI model.

Server composes a natural-language prompt sentence describing the room category, detected objects, user funding information, user emotional state, and the candidate article list in a constrained format.

Input: category information, object information, constraint information, and candidate article information.

Output: a prompt sentence string suitable for input to a generative AI model.

Server performs data processing by interpolating structured values into template text and ensuring that the prompt includes explicit instructions for output format and constraints.

### Step 13:

Server sends the prompt sentence to the generative AI model and receives response information.

Server transmits the constructed prompt sentence to a transformer-based generative AI model through an API call and waits for the generated text output.

Input: prompt sentence string.

Output: response information text including interior planning information generated by the model.

Server performs data computation by invoking the model's inference routine, which tokenizes the prompt, processes it through self-attention and feed-forward layers, and decodes a sequence of tokens forming the response.

### Step 14:

Server parses the response information to extract interior planning information.

Server applies a parsing routine to the response text to identify selected article references, quantities, and layout descriptions.

Input: response information text.

Output: structured interior planning information including selected article information and arrangement information.

Server performs data processing by scanning the text for known article identifiers or descriptions, mapping them back to candidate articles, and extracting relative placement directions from layout sentences using pattern matching or a lightweight language parser.

### Step 15:

Server generates scene information for visual representation.

Server constructs a scene graph or equivalent structure that represents the space geometry and includes nodes for each selected article positioned according to the arrangement information.

Input: selected article information, arrangement information, and approximate room parameters.

Output: scene information comprising nodes, transformations, materials, and camera parameters.

Server performs data computation by translating verbal layout descriptions into coordinates and orientations, assigning material properties from article attributes, and defining camera viewpoints that capture the arrangement.

### Step 16:

Server produces visual information using image generation or 3D rendering.

Server sends the scene information to a rendering engine or constructs a descriptive text prompt for an image generative model, and receives the rendered or generated image.

Input: scene information or derived visual description prompt.

Output: visual information in the form of at least one image file representing the planned interior.

Server performs data processing by converting scene nodes into geometric primitives and pixel values in a graphics pipeline, or by running a generative AI model that iteratively refines a latent image representation until a final image is produced.

### Step 17:

Server computes association information between visual regions and articles.

Server analyzes the rendered or generated image to locate image regions that correspond to each selected article, using rendering masks or object-detection results.

Input: visual information image and scene information or detection results.

Output: association information mapping predetermined regions in the image to article identifiers.

Server performs data computation by identifying pixel regions associated with each object ID or by evaluating bounding boxes produced by an object detector and linking them to known articles.

### Step 18:

Server sends visual information and association information to the terminal.

Server packages the image URL, association mapping, and article identifiers into a response and transmits it to the terminal.

Input: visual information and association information linked with a session ID.

Output: network response containing all resources needed for interactive display on the terminal.

Server performs data processing by serializing data structures into a compact format and managing caching or access control as necessary.

### Step 19:

Terminal displays the visual information and enables interactive selection.

Terminal downloads the image based on the received URL, renders it on the display, and overlays interactive elements at the predetermined regions indicated by the association information.

Input: image data and association mapping from the server.

Output: graphical user interface with clickable or tappable hotspots corresponding to articles.

Terminal performs data processing by converting coordinate regions into UI elements and mapping user interaction events to associated article identifiers.

### Step 20:

User selects visual regions to view article details.

User taps or clicks on a region of the displayed image, such as the sofa or table, to request more information about that article.

Input: user interaction events (touch coordinates or pointer clicks).

Output: selection signals sent from the terminal to the server, containing the region identifier or article identifier.

Terminal performs data processing by resolving the interaction position against the association mapping and forming a request for article details.

### Step 21:

Server retrieves product information and purchase connection information.

Server receives the selection request, identifies the corresponding article, and queries a product database or external service to retrieve current product information and purchase connection data.

Input: article identifier and session context.

Output: product information including name, description, price, and purchase connection information.

Server performs data computation by joining article entries with vendor entries, applying any necessary currency conversions, and formatting a response record.

### Step 22:

Server sends article details and purchase connection information to the terminal.

Server transmits the product information and purchase connection identifier to the terminal as a structured response.

Input: product information record.

Output: detail response containing display fields and a purchase link or resource identifier.

Server may also perform data processing to adapt content to the user's locale or currency settings.

### Step 23:

Terminal presents article details and initiates purchase access.

Terminal displays the article details in a dialog or panel and provides a “Buy” or “Open Store” button linked to the purchase connection information.

Input: product information and purchase link from the server.

Output: updated user interface and, when the user activates the purchase link, a navigation event to a network-based provision platform.

Terminal performs data processing by launching an embedded browser view or external browser and passing the purchase connection information as the target resource.

Step 24:

User provides feedback and optionally requests an alternative plan.

User rates the proposal, enters comments such as “I prefer more color” or “I need more storage,” and can request another plan within the same budget.

Input: user feedback via controls and text fields on the terminal.

Output: feedback data and updated constraints sent from the terminal to the server.

Terminal packages the feedback in association with the session ID and transmits it to the server.

### Step 25:

Server updates constraints and generates a new prompt sentence for refinement.

Server incorporates the feedback into the constraint information by adjusting style preferences or item-type priorities, and then constructs a new prompt sentence that explicitly references the reasons for dissatisfaction and the updated constraints.

Input: existing constraint information and user feedback data.

Output: refined prompt sentence for the generative AI model and updated constraint records.

Server performs data processing by modifying weights or flags in constraint structures and reassembling the prompt sentence to guide the generative AI model toward a revised interior planning solution.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

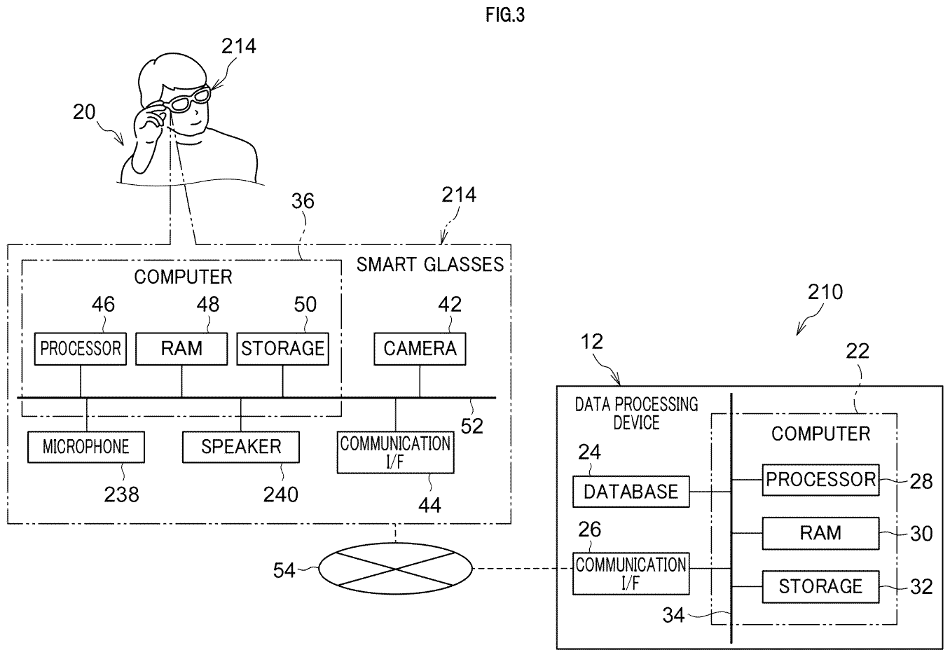

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

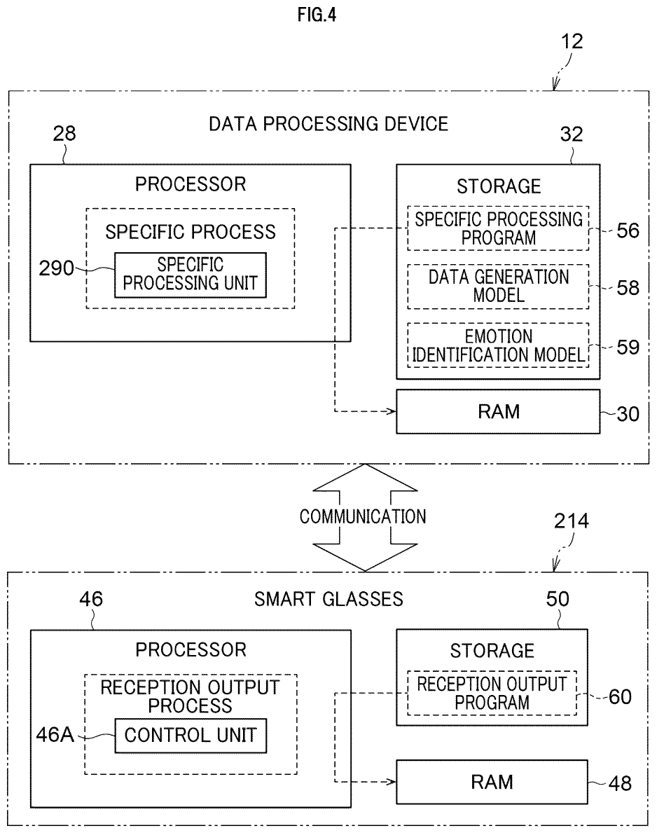

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

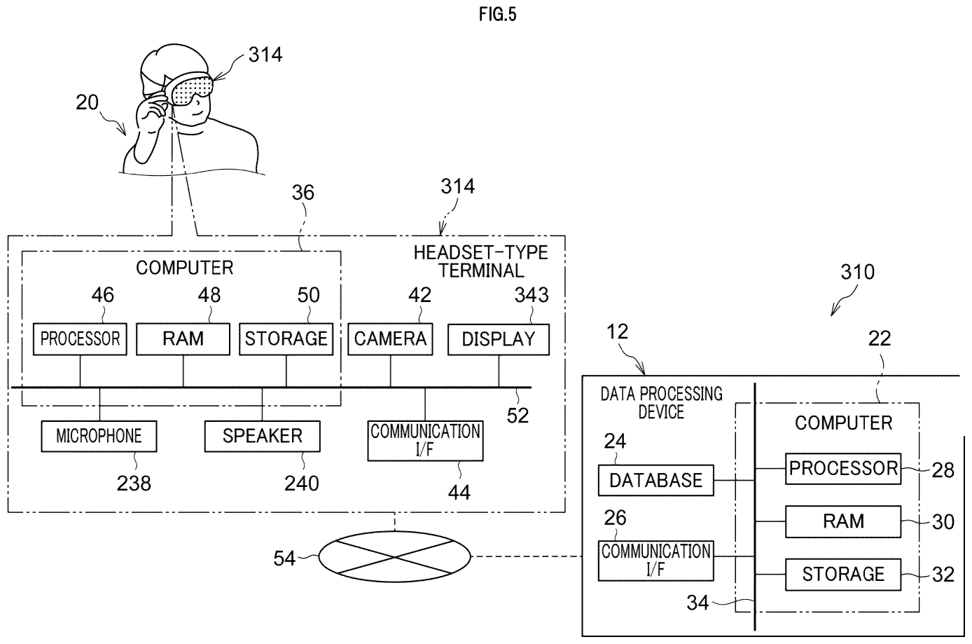

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

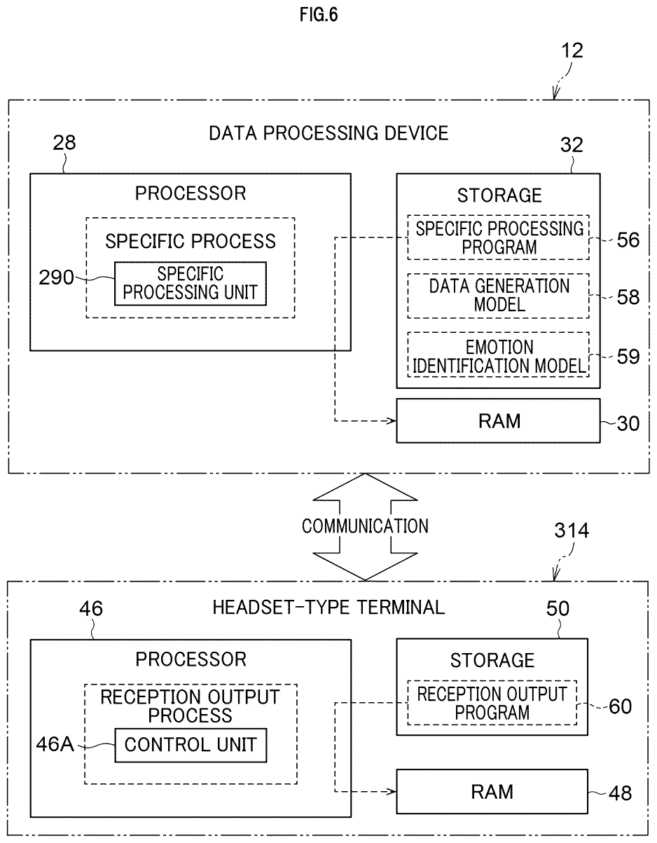

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

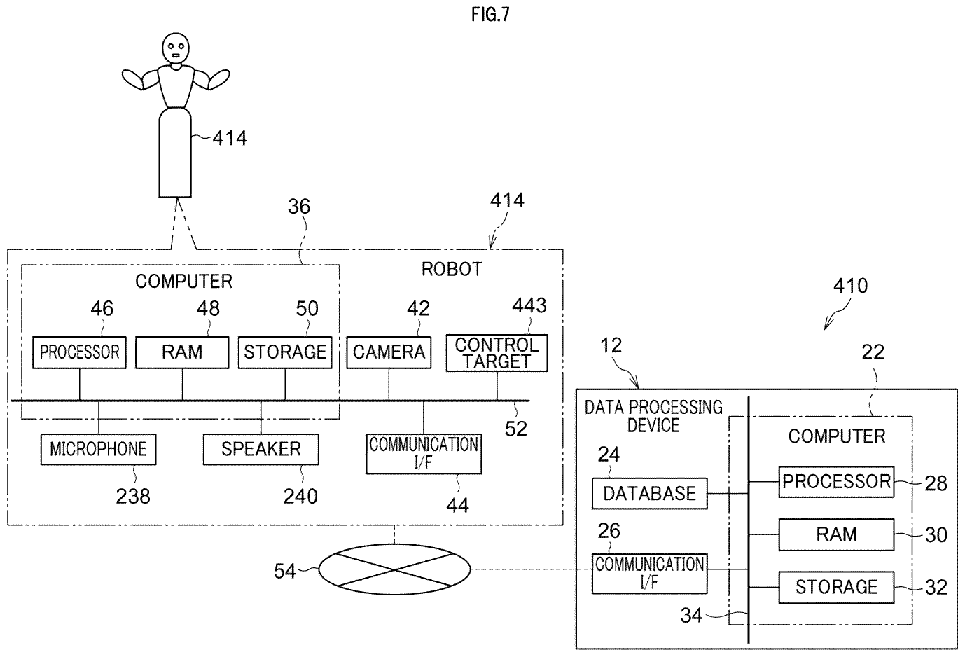

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

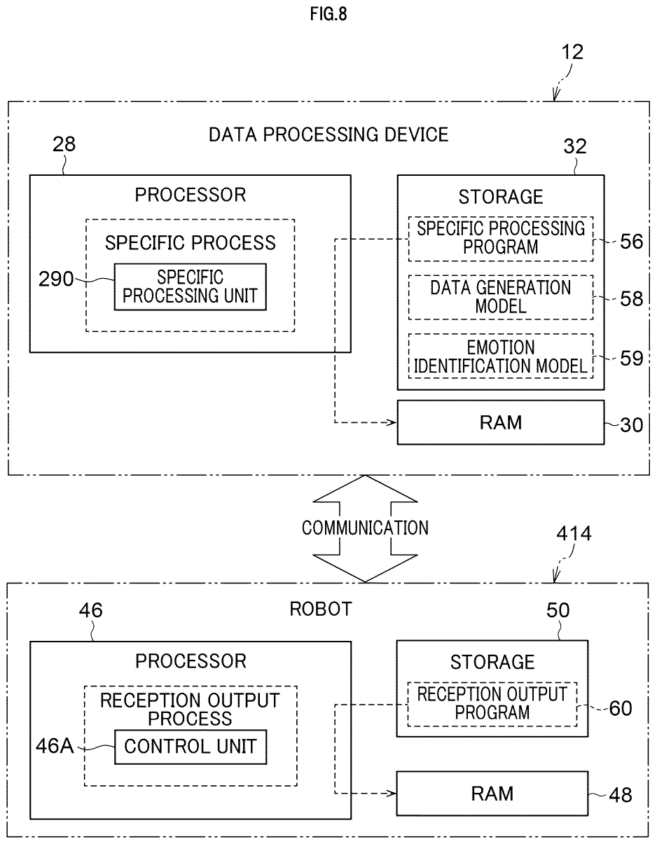

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

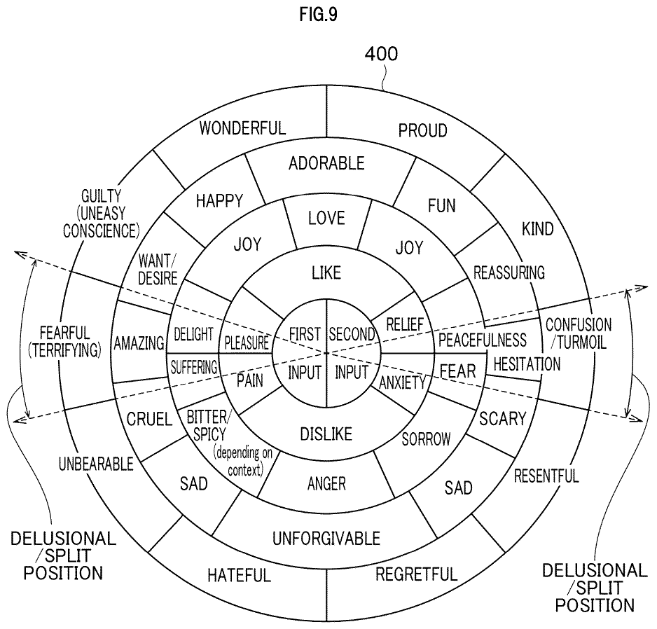

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

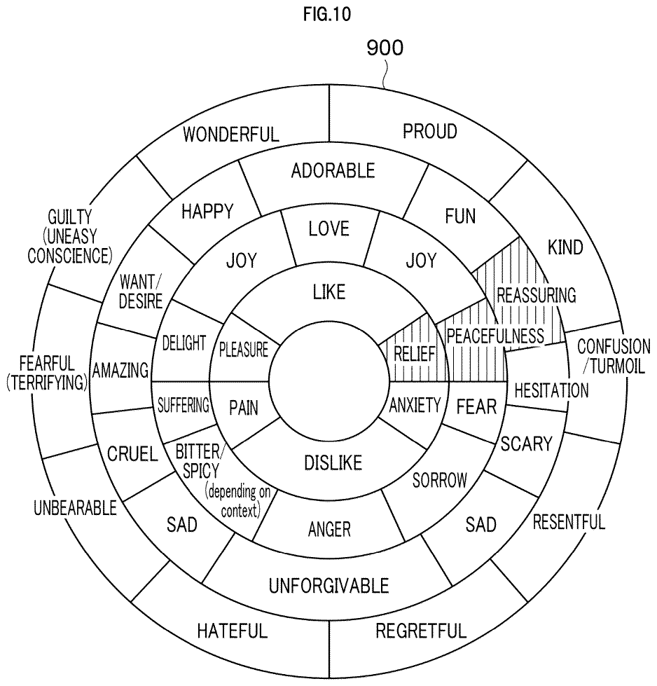

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to acquire image data of a space by using an imaging device,
preprocess the image data by using an image processing program, extract feature information of structural elements and color tones within the space based on pixel information, and determine category information of the space by inputting the feature information into an identification model,
generate interior planning information including interior components, color scheme information, and lighting information by using the category information and attribute information obtained from a user, based on template information stored in a data storage device,
generate a prompt sentence in a natural language description according to a space type, the interior components, the color scheme information, and the lighting information included in the interior planning information, and input the prompt sentence into a generative information generation model to generate image data that visually represents the interior planning information, and
transmit the generated image data to an output device and cause the output device to display the image data.

### (Supplementary 2)

The system according to supplementary 1,
wherein the processor is configured to analyze object regions in the generated image data, obtain article information corresponding to the object regions from the data storage device or an external information providing device, and present, to the output device, reference information for an electronic commerce information providing environment in which the articles are obtainable, based on the article information.

### (Supplementary 3)

The system according to supplementary 1,
wherein the processor is configured to process cost constraint information obtained from the user in generating the interior planning information and in generating the prompt sentence, select interior components that satisfy the cost constraint information, and include a description indicating the cost constraint information in the prompt sentence to be input into the generative information generation model, thereby generating image data representing a design plan based on the cost constraint information.

### Application Example 1

### (Supplementary 1)

A system comprising a processor,
wherein the processor is configured to receive, from a terminal including an imaging device, image data of a space and user condition data including preference information and budget information,
perform preprocessing on the image data of the space by using an image processing program to generate input data for feature extraction,
input the input data for feature extraction into a machine learning program to calculate feature amount data of the space, and determine a category of the space and an interior style category on the basis of the feature amount data and the user condition data,
generate a prompt sentence as a descriptive text including the category of the space, the interior style category, the feature amount data of the space, and the budget information,
input the prompt sentence and the image data of the space into a generative information generation program that is a generative AI model, and cause the generative information generation program to generate visual representation data of an interior design suitable for the space,
analyze the visual representation data of the interior design by using an image recognition program to specify article elements included in the visual representation data, and generate attribute information data for each of the article elements,
compare the attribute information data with product information data stored in a product information storage device, select a plurality of candidate products corresponding to the interior design, and calculate product combinations such that a total amount for each interior plan obtained by combining the candidate products falls within the budget information, and generate proposal information data for each interior plan, the proposal information data including information of the candidate products, the visual representation data of the interior design, the prompt sentence used for generation of the visual representation data, and
guidance information on facilities at which the candidate products are actually confirmable, and transmit the proposal information data to the terminal.

### (Supplementary 2)

The System According to Supplementary 1,
wherein the processor is configured to
generate a revised prompt sentence by updating contents of the prompt sentence on the basis of the attribute information data of the candidate products included in the proposal information data and evaluation information data received from a user, re-input the revised prompt sentence and the image data of the space into the generative information generation program that is the generative AI model, and thereby generate revised visual representation data of an interior design and corresponding candidate product information reflecting the evaluation information data of the user.

### (Supplementary 3)

The system according to supplementary 1,
wherein the processor is configured to
refer to a facility information storage device storing facility information corresponding to the candidate products, identify facilities at which the candidate products are actually confirmable on the basis of position information data of the user and position information data of the facilities, and include route guidance information to the facilities and handling information of the candidate products at the facilities in the proposal information data and provide the proposal information data to the terminal.

### Example 2

### (Supplementary 1)

A system comprising a processor,
wherein the processor is configured to
acquire an image of a space by using an imaging apparatus,
analyze the acquired image by information processing to extract a feature of the image and determine a category of the space,
generate, based on the determined category and design conditions including a prompt sentence received from a user, a prompt sentence to be input to a generative AI model, and instruct the generative AI model to generate a visual representation of an interior design,
obtain the visual representation of the interior design generated by the generative AI model, analyze the visual representation by using an image recognition algorithm to identify an element in the visual representation, and generate element information in which attribute information is assigned to each element,
search, based on the element information and budget information received from the user, an information storage device and an external information providing service to acquire product information corresponding to the element, and select the product information in consideration of the budget information, and
generate purchase connection information corresponding to the selected product information and provide the purchase connection information in association with the visual representation.

### (Supplementary 2)

The system according to supplementary 1,
wherein the processor is configured to
generate, in the element information, position information and classification information for each element in the visual representation, generate association information for associating the position information and the classification information with the product information, and
generate control information for causing a user terminal to display an association between the element in the visual representation and the purchase connection information based on the association information.

### (Supplementary 3)

The system according to supplementary 1,
wherein the processor is configured to
calculate a target price range for each element based on the budget information, execute an optimization process to select a combination of the product information that satisfies the target price range, and generate the purchase connection information according to a result of the optimization process.

### Application Example 2

### (Supplementary 1)

A system comprising a processor,
wherein the processor is configured to
acquire an image of a space by using an imaging device,
analyze the acquired image by applying an image processing algorithm to extract feature information including object information and style information, and determine category information of the space based on the feature information,
use the category information and constraint information including the object information, funding information acquired from a user, and state information of the user to search a storage device that stores candidate article information, and extract candidate article information that satisfies the constraint information,
generate a prompt sentence expressed in a natural language based on the category information and the candidate article information, and cause a generative information processing model to receive the prompt sentence as input and to output response information including interior planning information,
extract selected article information and arrangement information from the response information, and generate scene information for visual representation that defines an arrangement of the selected article information in the space,
input the scene information to an image generation algorithm or a three-dimensional rendering algorithm to generate visual information corresponding to the interior planning information, and store the visual information in association with the selected article information, and
use association information that associates predetermined regions in the visual information with the selected article information to cause a user terminal to display the visual information, and in response to an operation input on the predetermined regions by the user, present the selected article information.

### (Supplementary 2)

The System According to Supplementary 1,
wherein the processor is configured to
acquire product information corresponding to the selected article information based on the visual information and the association information, and transmit purchase connection information included in the product information to the user terminal so as to provide a connection to a network-based provision platform from which an article corresponding to the predetermined regions in the visual information is obtainable.

### (Supplementary 3)

The system according to supplementary 1,
wherein the processor is configured to
include the funding information and the state information of the user in the prompt sentence as the constraint information to cause the generative information processing model to generate interior planning information that conforms to a funding condition and a user state, and select, from the response information, an interior design plan that satisfies the funding condition, and present the interior design plan as the visual information.

What is claimed is:

1. A system comprising:
circuitry configured to receive, via a packet-switched network, sensor signal data captured by an imaging sensor of a terminal device;
apply a trained convolutional neural network to the sensor signal data to extract a multidimensional feature vector representing structural attributes and chromatic distribution information;
input the multidimensional feature vector into a classification model to determine category label data indicating a classification of a spatial region represented in the sensor signal data;
generate, based on the category label data, a structured input sequence for a generative neural network model, the structured input sequence encoding at least the category label data and configuration parameters; and
transmit, via the packet-switched network, output data generated by the generative neural network model in response to the structured input sequence to the terminal device for rendering on a display of the terminal device.

2. The system according to claim 1, wherein the circuitry is further configured to preprocess the sensor signal data by performing color space conversion, resolution normalization, and noise reduction to generate a normalized tensor representation prior to applying the trained convolutional neural network.

3. The system according to claim 2, wherein the trained convolutional neural network comprises a plurality of convolutional layers, pooling layers, and fully connected layers, and wherein extracting the multidimensional feature vector comprises computing low-level feature descriptors including edge maps and color histograms from the normalized tensor representation and concatenating the low-level feature descriptors with a high-level feature vector obtained from an intermediate layer of the trained convolutional neural network.

4. The system according to claim 3, wherein the category label data indicates an environmental configuration type of the spatial region, and wherein the circuitry is further configured to access template data records stored in a storage device, each template data record comprising component identifiers, chromatic scheme data, and illumination parameter data associated with the environmental configuration type.

5. The system according to claim 4, wherein the environmental configuration type corresponds to a room style category, the component identifiers correspond to furniture and fixture types, the chromatic scheme data specifies wall and surface color attributes, and the illumination parameter data specifies lighting arrangement information, and wherein the structured input sequence encodes a natural language description of an interior design plan conforming to the room style category.

6. The system according to claim 1, wherein the generative neural network model comprises a diffusion-based neural network that iteratively refines a latent representation through a sequence of denoising operations conditioned on an encoded representation of the structured input sequence.

7. The system according to claim 6, wherein the circuitry is further configured to encode the structured input sequence into a numeric embedding vector using a transformer-based text encoder, and to supply the numeric embedding vector as a conditioning signal to the diffusion-based neural network during each denoising operation.

8. The system according to claim 7, wherein the circuitry is further configured to specify generation parameters including a number of denoising steps, a guidance strength value, and a target resolution, and to decode a final latent representation into pixel-level output data for transmission to the terminal device.

9. The system according to claim 1, wherein the circuitry is further configured to apply an object detection model to the output data generated by the generative neural network model to identify a plurality of element regions within the output data, each element region associated with a bounding box and a classification label.

10. The system according to claim 9, wherein the circuitry is further configured to compute, for each element region, attribute feature data comprising a dominant color descriptor, an aspect ratio value, and a texture descriptor derived from pixel values within the bounding box.

11. The system according to claim 10, wherein the circuitry is further configured to compare the attribute feature data for each element region with data records stored in a storage device using a similarity metric, and to select, from the data records, candidate data records having similarity scores exceeding a predetermined threshold.

12. The system according to claim 11, wherein the data records comprise product information records each including a product identifier, a price value, and a resource locator for an electronic commerce platform, and wherein the circuitry is further configured to transmit the resource locator for each selected candidate data record to the terminal device for display as an interactive element overlaid on the output data.

13. The system according to claim 1, wherein the circuitry is further configured to receive, via the packet-switched network, constraint parameter data from the terminal device, and to incorporate the constraint parameter data into the structured input sequence for the generative neural network model.

14. The system according to claim 13, wherein the constraint parameter data comprises a numerical upper bound value, and wherein the circuitry is further configured to filter configuration parameters based on the numerical upper bound value prior to generating the structured input sequence.

15. The system according to claim 14, wherein the numerical upper bound value represents a budget constraint, and wherein the circuitry is further configured to execute a combinatorial optimization process that selects a combination of candidate data records such that a sum of associated numerical attribute values does not exceed the numerical upper bound value while maximizing a compatibility score.

16. The system according to claim 1, wherein the circuitry is further configured to receive, via the packet-switched network, evaluation data from the terminal device indicating a modification request, and to generate a revised structured input sequence based on the evaluation data and the category label data.

17. The system according to claim 16, wherein the circuitry is further configured to input the revised structured input sequence together with the sensor signal data into the generative neural network model to generate revised output data, and to transmit the revised output data to the terminal device via the packet-switched network.

18. A system comprising:
circuitry configured to
receive, via a packet-switched network, sensor signal data captured by an imaging sensor of a terminal device and user condition data including preference parameter data and a numerical constraint value;
apply a trained convolutional neural network to the sensor signal data to compute feature amount data representing spatial layout attributes, chromatic distribution information, and detected object categories;
determine, based on the feature amount data and the user condition data, a spatial region category and a style category by computing similarity scores between the feature amount data and a plurality of stored profile vectors;
generate a structured input sequence as a descriptive text encoding the spatial region category, the style category, the feature amount data, and the numerical constraint value;
input the structured input sequence and the sensor signal data into a generative neural network model to generate visual representation data;
apply an object detection model to the visual representation data to identify element regions and to generate attribute information data for each element region;
compare the attribute information data with data records stored in a storage device to select candidate data records, and execute a combinatorial optimization process to determine a combination of the candidate data records satisfying the numerical constraint value; and
transmit, via the packet-switched network, proposal data comprising the visual representation data, information of the candidate data records, and the structured input sequence to the terminal device for rendering on a display of the terminal device.

19. The system according to claim 18, wherein the circuitry is further configured to receive evaluation data from the terminal device, update the structured input sequence based on the evaluation data, re-input the updated structured input sequence and the sensor signal data into the generative neural network model to generate revised visual representation data, and transmit revised proposal data including the revised visual representation data and updated candidate data records to the terminal device via the packet-switched network.

20. A method performed by a system comprising circuitry, the method comprising:
receiving, via a packet-switched network, sensor signal data captured by an imaging sensor of a terminal device;
applying a trained convolutional neural network to the sensor signal data to extract a multidimensional feature vector representing structural attributes and chromatic distribution information;
inputting the multidimensional feature vector into a classification model to determine category label data indicating a classification of a spatial region represented in the sensor signal data;
generating, based on the category label data, a structured input sequence for a generative neural network model, the structured input sequence encoding at least the category label data and configuration parameters; and
transmitting, via the packet-switched network, output data generated by the generative neural network model in response to the structured input sequence to the terminal device for rendering on a display of the terminal device.
